(19) United States
(12) Patent Application Publication
(10) Pub. No.: US 2013/0204941 A1
(43) Pub. Date: Aug. 8, 2013

(54) METHOD AND SYSTEM FOR DISTRIBUTED PROCESSING

(71) Applicant: FUJITSU LIMITED, Kawasaki-shi (JP)

(72) Inventors: Yasuo YAMANE, Machida (JP); Nobutaka IMAMURA, Yokohama (JP); Yuichi TSUCHIMOTO, Kawasaki (JP); Toshiaki SAEKI, Kawasaki (JP)

(73) Assignee: FUJITSU LIMITED, Kawasaki-shi (JP)

(21) Appl. No.: 13/759,111

(22) Filed: Feb. 5, 2013

(30) Foreign Application Priority Data
Feb. 6, 2012 (JP) 2012-022905

(51) Int. Cl. H04L 29/08

(52) U.S. Cl. CPC H04L 67/10
USPC 709/204

(57) ABSTRACT

Nodes at first, second, and third locations have the same first-axis coordinates, while nodes at the first, fourth, and fifth locations have the same second-axis coordinates. First transmission transmits data elements from the node at the first location to nodes at the second and fourth locations, as well as to the node at either the third location or the fifth location. Second transmission transmits data elements from nodes at the second locations to nodes at the first, fourth, and fifth locations. Third transmission transmits data elements from nodes at the third locations to nodes at the first, second, and fourth locations. These three transmissions are performed with each node location selected as the base point on a diagonal line. The nodes execute a data processing operation by using the data elements assigned thereto and the data elements received as a result of the first to third transmissions.

### CROSS-REFERENCE TO RELATED APPLICATION

This application is based upon and claims the benefit of priority of the prior Japanese Patent Application No. 2012-022905, filed on Feb. 6, 2012, the entire contents of which are incorporated herein by reference.

### FIELD

The embodiments discussed herein relate to a method and system for distributed processing.

### BACKGROUND

Distributed processing systems are widely used today to process large amounts of data by running programs therefor on a plurality of nodes (e.g., computers) in parallel. These systems may also be referred to as parallel data processing systems. Some parallel data processing systems use high-level data management software, such as parallel relational databases and distributed key-value stores. Other parallel data processing systems operate with user-implemented parallel processing programs, without relying on high-level data management software.

The above systems may exert data processing operations on a set (or sets) of data elements. In the technical field of relational database, for example, a join operation acts on each combination of two data records (called “tuples”) in one or two designated data tables. Another example of data processing is matrix product and other operations that act on one or two sets of vectors expressed in matrix form. Such operations are used in the scientific and technological fields.

It is preferable that the nodes constituting a distributed processing system are utilized as efficiently as possible to process a large number of data records. To this end, there has been proposed, for example, an n-dimensional hypercubic parallel processing system. In operation of this system, two datasets are first distributed uniformly to a plurality of cells. The data is then broadcast from each cell for other cells within a particular range before starting computation of a direct product of the two datasets. Another example is a parallel computer including a plurality of computing elements organized in the form of a triangular array. This array of computing elements is subdivided to form a network of smaller triangular arrays.

Yet another example is a parallel processor device having a first group of processors, a second group of processors, and an intermediate group of processor between the two. The first group divides and distributes data elements to the intermediate group. The intermediate group sorts the data elements into categories and distributes them to the second group so that the processors of the second group each collect data elements of a particular category. Still another example is an array processor that includes a plurality of processing elements arranged in the form of a rectangle. Each processing element has only one receive port and only one transmit port, such that the elements communicate via limited paths. Further proposed is a parallel computer system formed from a plurality of divided processor groups. Each processor group performs data transfer in its local domain. The data is then transferred from group to group in a stepwise manner.

There is proposed still another distributed processing system designed for solving computational problems. A given group of processors is divided into a plurality of subsystems having a hierarchical structure. A given computational problem is also divided into a plurality of subproblems having a hierarchical structure. These subproblems are subjected to different subsystems, so that the given problem is solved by the plurality of subsystems as a whole. Communication between two subsystems is implemented in this distributed processing system, with a condition that the processors in one subsystem are only allowed to communicate with their associated counterparts in another subsystem. Suppose, for example, that one subsystem includes processors #000 and #001, while another subsystem includes processors #010 and #011. Processor #000 communicates with processor #010, and processor #001 communicates with processor #011. The inter-processor communication may therefore take two stages of, for example, communication from subsystem to subsystem and closed communication within a subsystem.

The following is a list of documents pertinent to the background techniques:

Japanese Laid-open Patent Publication No. 2-163866

Japanese Laid-open Patent Publication No. 6-19862

Japanese Laid-open Patent Publication No. 9-6732

International Publication Pamphlet No. WO 99/00743

Japanese Laid-open Patent Publication No. 2003-67354

Shantanu Dutt and Nam Trinh, “Are There Advantages to High-Dimension Architectures?: Analysis of K-ary n-cubes for the Class for Parallel Divide-and-Conquer Algorithms”, Proceedings of the 10th ACM (Association for Computing Machinery) International Conference on Supercomputing (ICS), 1996

As in the case of join operations mentioned above, some classes of data processing operations may use the same data elements many times. When a plurality of nodes are used in parallel to execute this type of operations, one or more copies of data elements have to be transmitted from node to node. Here the issue is how efficiently the nodes obtain data elements for their local operations.

Suppose, for example, that the nodes exert a specific processing operation on every possible combination pattern of two data elements in a dataset. The data processing calls for complex scheduling of tasks, and it is not easy in such cases for the nodes to duplicate and transmit their data elements in an efficient way.

### SUMMARY

According to an aspect of the embodiments discussed herein, there is provided a method for distributed processing including the following acts: assigning data elements to a plurality of nodes sitting at node locations designated by first-axis coordinates and second-axis coordinates in a coordinate space, the node locations including a first location that serves as a base point on a diagonal line of the coordinate space, second and third locations having the same first-axis coordinates as the first location, and fourth and fifth locations having the same second-axis coordinates as the first location; performing first, second, and third transmissions, with each node location on the diagonal line which is selected as the base point, wherein: the first transmission transmits the assigned data elements from the node at the first location as the base point to the nodes at the second and fourth locations, as well as to the node at either the third location or the fifth location, the second transmission transmits the assigned data elements from the nodes at the second locations to the nodes at the first, fourth, and fifth locations, and the third transmission transmits the assigned data elements from the nodes at the third locations to the nodes at the first, second, and fourth locations; and causing the nodes to execute a data processing operation by using the data elements assigned thereto by the assigning and the data elements received as a result of the first, second, and third transmissions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a distributed processing system according to a first embodiment;

FIG. 2 illustrates a distributed processing system according to a second embodiment;

FIG. 3 illustrates an information processing system according to a third embodiment;

FIG. 4 is a block diagram illustrating an exemplary hardware configuration of nodes;

FIG. 5 illustrates an exhaustive join;

FIG. 6 illustrates an exemplary execution result of an exhaustive join;

FIG. 7 illustrates a node coordination model according to the third embodiment;

FIG. 8 is a graph illustrating how the amount of transmit data varies with the row dimension of nodes;

FIGS. 9A, 9B, and 9C illustrate exemplary methods of relaying from node to node;

FIG. 10 is a block diagram illustrating an exemplary software structure according to the third embodiment;

FIG. 11 is a flowchart illustrating an exemplary procedure of joins according to the third embodiment;

FIG. 12 illustrates a first diagram illustrating an exemplary data arrangement according to the third embodiment;

FIG. 13 is a second diagram illustrating an exemplary data arrangement according to the third embodiment;

FIG. 14 is a third diagram illustrating an exemplary data arrangement according to the third embodiment;

FIG. 15 illustrates an information processing system according to a fourth embodiment;

FIG. 16 illustrates a node coordination model according to the fourth embodiment;

FIG. 17 is a block diagram illustrating an exemplary software structure according to the fourth embodiment;

FIG. 18 is a flowchart illustrating an exemplary procedure of joins according to the fourth embodiment;

FIG. 19 is a first diagram illustrating an exemplary data arrangement according to the fourth embodiment;

FIG. 20 is a second diagram illustrating an exemplary data arrangement according to the fourth embodiment;

FIG. 21 is a third diagram illustrating an exemplary data arrangement according to the fourth embodiment;

FIG. 22 is a fourth diagram illustrating an exemplary data arrangement according to the fourth embodiment;

FIG. 23 illustrates a triangle join;

FIG. 24 illustrates an exemplary result of a triangle join;

FIG. 25 illustrates a node coordination model according to a fifth embodiment;

FIG. 26 is a flowchart illustrating an exemplary procedure of joins according to the fifth embodiment;

FIG. 27 is a first diagram illustrating an exemplary data arrangement according to the fifth embodiment;

FIG. 28 is a second diagram illustrating an exemplary data arrangement according to the fifth embodiment;

FIG. 29 illustrates a node coordination model according to a sixth embodiment;

FIG. 30 is a flowchart illustrating an exemplary procedure of joins according to the sixth embodiment;

FIG. 31 is a first diagram illustrating an exemplary data arrangement according to the sixth embodiment;

FIG. 32 is a second diagram illustrating an exemplary data arrangement according to the sixth embodiment;

FIG. 33 illustrates a node coordination model according to a seventh embodiment;

FIG. 34 is a flowchart illustrating an exemplary procedure of joins according to the seventh embodiment;

FIG. 35 is a first diagram illustrating an exemplary data arrangement according to the seventh embodiment;

FIG. 36 is a second diagram illustrating an exemplary data arrangement according to the seventh embodiment;

FIG. 37 is a flowchart illustrating an exemplary procedure of joins according to an eighth embodiment;

FIG. 38 is a first diagram illustrating an exemplary data arrangement according to the eighth embodiment;

FIG. 39 is a second diagram illustrating an exemplary data arrangement according to the eighth embodiment;

FIG. 40 illustrates a node coordination model according to a ninth embodiment;

FIG. 41 is a flowchart illustrating an exemplary procedure of joins according to the ninth embodiment;

FIG. 42 a first diagram illustrating an exemplary data arrangement according to the ninth embodiment;

FIG. 43 is a second diagram illustrating an exemplary data arrangement according to the ninth embodiment;

FIG. 44 is a third diagram illustrating an exemplary data arrangement according to the ninth embodiment;

FIG. 45 illustrates a node coordination model according to a tenth embodiment;

FIG. 46 is a flowchart illustrating an exemplary procedure of joins according to the tenth embodiment;

FIG. 47 is a first diagram illustrating an exemplary data arrangement according to the tenth embodiment;

FIG. 48 is a second diagram illustrating an exemplary data arrangement according to the tenth embodiment;

FIG. 49 is a third diagram illustrating an exemplary data arrangement according to the tenth embodiment;

FIG. 50 is a fourth diagram illustrating an exemplary data arrangement according to the tenth embodiment; and

FIG. 51 is a fifth diagram illustrating an exemplary data arrangement according to the tenth embodiment.

### DESCRIPTION OF EMBODIMENTS

Several embodiments will be described below with reference to the accompanying drawings.

### (a) First Embodiment

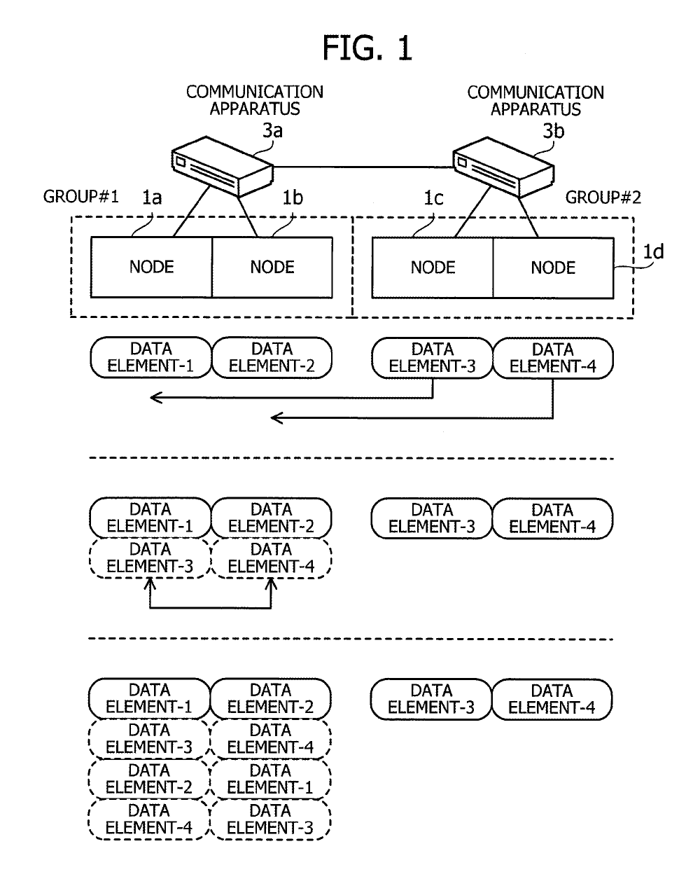

FIG. 1 illustrates a distributed processing system according to a first embodiment. The illustrated distributed processing system includes a plurality of nodes 1a, 1b, 1c, and 1d and communication devices 3a and 3b.

Nodes 1a, 1b, 1c, and 1d are information processing apparatuses configured to execute data processing operations. Each node 1a, 1b, 1c, and 1d may be organized as a computer system including a processor such as a central processing unit (CPU) and data storage devices such as random access memory (RAM) and hard disk drives (HDD). For example, the nodes 1a, 1b, 1c, and 1d may be what are known as personal computers (PC), workstations, or blade servers. Communication devices 3a and 3b are network relaying devices designed to forward data from one place to another place. For example, the communication devices 3a and 3b may be layer-2 switches. These two communication devices 3a and 3b may be interconnected by a direct link as seen in FIG. 1, or may be connected via some other network devices in a higher level of the network hierarchy.

Two nodes 1a and 1b are linked to one communication device 3a and form a group #1 of nodes. Another two nodes 1c and 1d are linked to the other communication device 3b and form another group #2 of nodes. Each group may include three or more nodes. Further, the distributed processing system may include more groups of nodes. Each such node group may be regarded as a single node, and is hence referred to as a virtual node. There are node-to-node relationships between every two groups of nodes in the system. For example, one node 1a in group #1 is associated with one node 1c in group #2, while the other node 1b in group #1 is associated with the other node 1d in group #2.

A plurality of data elements constituting a dataset are assigned to the nodes 1a, 1b, 1c, and 1d in a distributed manner. These data elements may previously be assigned before a command for initiating data processing is received. Alternatively, the distributed processing system may be configured to assign data elements upon receipt of a command that initiates data processing. Preferably, data elements are distributed as evenly as possible across the plurality of nodes used for the subsequent data processing, without redundant duplication (i.e., without duplication of the same data in different nodes). The distributed data elements may belong to a single dataset, or may belong to two or more different datasets. In other words, the distributed data elements may be of a single category, or may be divided into two or more categories.

Subsequent to the above initial data assignment, the nodes 1a, 1b, 1c, and 1d duplicate the data elements in preparation for the parallel data processing. That is, the data elements are copied from node to node, such that the nodes 1a, 1b, 1c, and 1d obtain a collection of data elements that they use in their local data processing. According to the first embodiment, the distributed processing system performs this duplication processing in the following two stages: (a) first stage where data elements are copied from group to group, and (b) second stage where data elements are copied from node to node in each group.

Group #1 receives data elements from group #2 in the first stage. More specifically, one node 1a in group #1 receives data elements from its counterpart node 1c in group #2 by communicating therewith via the communication devices 3a and 3b. Another node 1b in group #1 receives data elements from its counterpart node 1d in group #2 by communicating therewith via the communication devices 3a and 3b. Group #2 may similarly receive data elements from group #1 in the first stage. The nodes 1c and 1d in group #2 respectively communicate with their counterpart nodes 1a and 1d via communication devices 3a and 3b to receive their data elements.

In the second stage, group #1 locally duplicates data elements. More specifically, the nodes 1a and 1b in group #1 have their data elements, some of which have initially been assigned to each group, and the others of which have been received from group #2 or other groups, if any. The nodes 1a and 1b transmit and receive these data elements to and from each other. The decision of which node to communicate with which node is made on the basis of logical connections of nodes in group #1. For example, one node 1a receives data elements from the other node 1b, including those initially assigned thereto, and those received from the node 1d in group #2 in the first stage. Likewise, the latter node 1b receives data elements from the former node 1a, including those initially assigned thereto, and those received from the node 1c in group #2 in the first stage. The nodes 1c and 1d in group #2 may duplicate their respective data elements in the same way.

The four nodes 1a, 1b, 1c, and 1d execute data processing operations on the data elements collected through the two-stage duplication described above. As noted above, the current data elements in each node include those initially assigned thereto, those received in the first stage from its associated nodes in other groups, and those received in the second stage from nodes in the same group. For example, such data elements in a node may constitute two subsets of a given dataset. When this is the case, the node may apply the data processing operations on every combination of two data elements that respectively belong to these two subsets. As another example, data elements in a node may constitute one subset of a given dataset. When this is the case, the node may apply the data processing operations on every combination of two data elements both belonging to that subset.

According to the first embodiment, the proposed distributed processing system forms a plurality of nodes 1a, 1b, 1c, and 1d into groups, with consideration of their connection with communication devices 3a and 3b. This feature enables the nodes to duplicate and send data elements that they use in their local data processing.

Another possible method may be, for example, to propagate data elements of one node 1c successively to other nodes 1d, 1a, and 1b, as well as propagating those of another node 1d successively to other nodes 1a, 1b, and 1c. In that method, however, the delay times of communication between nodes 1a and 1b or between nodes 1c and 1d are different from those between nodes 1b and 1c or between nodes 1d and 1a, because the former involves only a single intervening communication device whereas the latter involves two intervening communication devices. In contrast, the proposed method delivers data elements in two stages, first via two or more intervening communication devices, and second within the local domain of each communication device. This method makes it easier to parallelize the operation of communication.

While the above-described first embodiment forms a single layer of groups, it is possible to form two or more layers of nested groups. Where appropriate in the system operations, the two communication devices 3a and 3b in the first embodiment may be integrated into a single device, so that the nodes 1a and 1b in group #1 are connected with the nodes 1c and 1d in group #2 via that single communication device.

As will be described later in a third embodiment and other subsequent embodiments, the groups of nodes execute exhaustive joins and triangle joins in a parallel fashion. It is noted that the same concept of node grouping discussed above in the first embodiment may also be applied to other kinds of parallel data processing operations. For example, the proposed concept of node grouping may be combined with the parallel sorting scheme of Japanese Patent No. 2509929, the invention made by one of the applicants of the present patent application. Other possible applications may include, but not limited to, the following processing operations: hash joins in the technical field of database, grouping of data with hash functions, deduplication of data records, mathematical operations (e.g., intersection and union) of two datasets, and merge joins using sorting techniques.

In general, the above-described concept of node grouping is applicable to computational problems that may be solved by using a so-called “divide-and-conquer algorithm.” This algorithm works by breaking down a problem into two or more sub-problems of the same type and combining the solutions to the sub-problems to give a solution to the original problem. A network of computational nodes solves such problems by exchanging data elements from node to node.

### (b) Second Embodiment

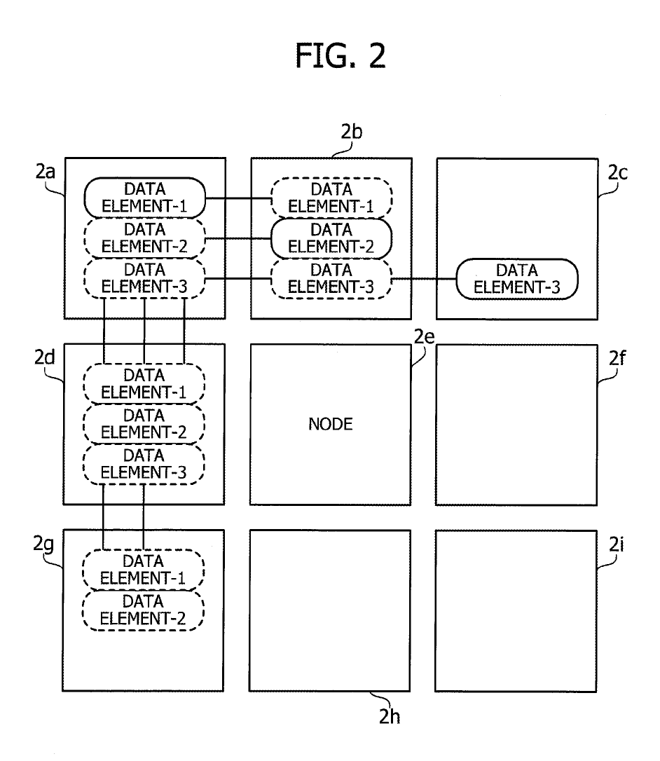

FIG. 2 illustrates a distributed processing system according to a second embodiment. The illustrated distributed processing system of the second embodiment is formed from a plurality of nodes 2a to 2i. These nodes 2a to 2i may each be an information processing apparatus for data processing or, more specifically, a computer including a processor(s) (e.g., CPU) and storage devices (e.g., RAM and HDD). The nodes 2a to 2i may all be linked to a single communication device (e.g., layer-2 switch) or may be distributed in the domains of different communication devices.

The nodes 2a to 2i are sitting at different node locations designated by first-axis coordinates and second-axis coordinates in a coordinate space. The first axis and second axis may be X axis and Y axis, for example. In this coordinate space, the nodes are logically arranged in a lattice network. Out of these nine nodes 2a to 2i, three nodes 2a, 2e, and 2i are located on a diagonal line of the coordinate space, which runs from the top-left corner to the bottom-right corner in FIG. 2. Suppose now that one location #1 on the diagonal line is set as a base point. Then relative to this base-point location #1, two more locations #2 and #3 are defined as having first-axis coordinate values equal to that of location #1. Likewise, another two locations #4 and #5 are defined as having second-axis coordinate values equal to that of location #1. It is noted that each of those locations #2, #3, #4, and #5 may actually be a plurality K of locations for K nodes, where K is an integer greater than zero. Referring to the example of FIG. 2, the base point (or location #1) is set to the top-left node 2a. Then node 2b is at location #2, node 2c at location #3, node 2d at location #4, and node 2g at location #5, where K=1.

Each node 2a to 2i receives one or more data elements of a dataset. These data elements may previously be assigned before reception of a command that initiates data processing. Alternatively, the distributed processing system may be configured to assign data elements upon receipt of a command that initiates data processing. Preferably, data elements are distributed as evenly as possible over the plurality of nodes to be used in the requested data processing, without duplication of the same data in different nodes. The distributed data elements may be of a single category (i.e., belong to a single dataset).

The data elements are duplicated from node to node during a specific period between their initial assignment and the start of parallel processing, so that the nodes 2a to 2i collect data elements for their own use. More specifically, the distributed processing system of the second embodiment executes the following first to third transmissions for each different base-point node (or location #1) on a diagonal line of the coordinate space.

In the first transmission, the node at location #1 transmits its local data elements to other nodes at locations #2 and #4. When, for example, the base point is set to the top-left node 2a, the data element initially assigned to the base-point node 2a is copied to other nodes 2b and 2d. The first transmission further includes selective transmission of data elements of the node at location #1 to either the node at location #3 or the node at location #5. Referring to the example of FIG. 2, the data element of the base-point node 1a is copied to either the node 2c or the node 2g. As a result of the above, the element in the base-point node 2a is duplicated in the nodes 2b, 2d, and 2c, while the others are duplicated to the nodes 2b, 2c, and 2g. In the case where the base-point node 2a has a plurality of data elements to duplicate, it is preferable to equalize the two nodes 2c and 2g as much as possible in terms of the number of data elements that they may receive from the base-point node 2a. For example, the difference between these nodes 2c and 2g in the number of data elements is managed so as not to exceed one.

In the second transmission, the node at location #2 transmits its local data elements to other nodes at locations #1, #4, and #5. For example (assuming the same base-point node 2a), the data element initially assigned to the node 2b is copied to other nodes 2a, 2d, and 2g.

In the third transmission, the node at location #3 transmits its local data elements to other nodes at locations #1, #2, and #4. For example (assuming the same base-point node 2a), the data element initially assigned to the node 2c is copied to other nodes 2a, 2b, and 2d.

In the case where K is greater than one (i.e., there are K nodes at K locations #2), each of the K nodes at locations #2 transmits its data elements to the (K−1) peer nodes in the second transmission. This note similarly applies to K nodes at locations #3 in the third transmission.

As a result of the above-described three transmissions, the base-point node at diagonal location #1 now has a collection of data elements initially assigned to nodes at locations #1, #2, and #3 sharing the same first-axis coordinate. The nodes at locations #3 and #5 have different fractions of those data elements in the base-point node at location #1, whereas the nodes at locations #2 and #4 have the same data elements as those in the node at location #1.

Each node then executes data processing by using their own collections of data elements, which include those initially assigned thereto and those received as a result of the first to third transmissions described above. For example, diagonal nodes may execute data processing with each combination of data elements collected by the diagonal nodes as base-point nodes. Non-diagonal nodes, on the other hand, may execute data processing by combining two sets of data elements collected by setting two different base-point nodes on the diagonal line.

According to the second embodiment, the proposed distributed processing system propagates data elements from node to node in an efficient way, after assigning data elements to a plurality of nodes 2a to 2i. Particularly, the proposed system enables effective parallelization of data processing operations that are exerted on every combination of two data elements in a dataset. The second embodiment duplicates data elements to the nodes 2a to 2i without excess or shortage, besides distributing the load of data processing as evenly as possible.

### (c) Third Embodiment

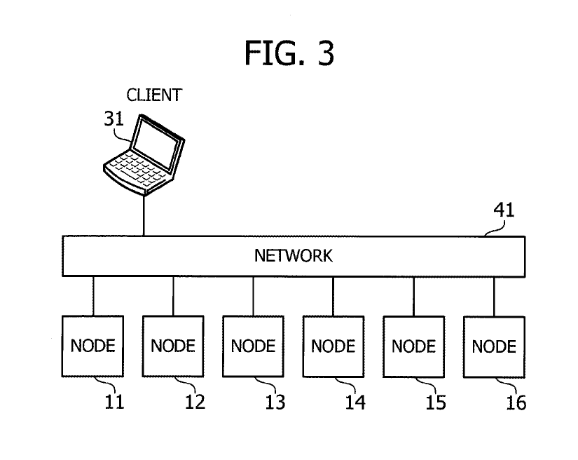

FIG. 3 illustrates an information processing system according to a third embodiment. This information processing system is formed from a plurality of nodes 11 to 16, a client 31, and a network 41.

The nodes 11 to 16 are computers connected to a network 41. More particularly, the nodes 11 to 16 may be PCs, workstations, or blade servers, capable of processing data in a parallel fashion. While not explicitly depicted in FIG. 3, the network 41 includes one or more communication devices (e.g., layer-2 switches) to transfer data elements and command messages. The client 31 is a computer that serves as a terminal console for the user. For example, the client 31 may send a command to one of the nodes 11 to 16 vial the network 41 to initiate a specific data processing operation.

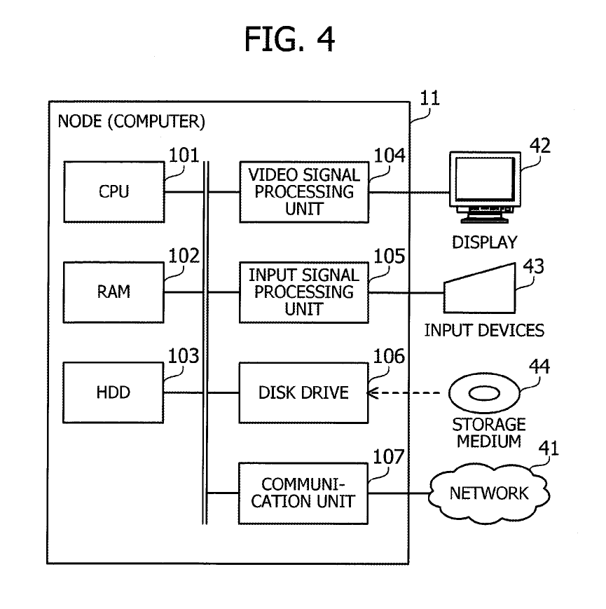

FIG. 4 is a block diagram illustrating an exemplary hardware configuration of nodes. The illustrated node 11 includes a CPU 101, a RAM 102, an HDD 103, a video signal processing unit 104, an input signal processing unit 105, a disk drive 106, and a communication unit 107. While FIG. 4 illustrates one node 11 alone, this hardware configuration may similarly apply to the other nodes 12 to 16 as well as to the client 31. It is noted that the video signal processing unit 104 and input signal processing unit 105 may be optional (i.e., add-on devices to be mounted when a need arises) as in the case of blade servers. That is, the nodes 11 to 16 may be configured to work without those processing units.

The CPU 101 is a processor that controls the node 11. The CPU 101 reads at least part of program files and data files stored in the HDD 103 and executes programs after loading them on the RAM 102. The node 11 may include a plurality of such processors.

The RAM 102 serves as volatile temporary memory for at least part of the programs that the CPU 101 executes, as well as for various data that the CPU 101 needs when executing the programs. The node 11 may include other type of memory devices than RAM.

The HDD 103 serves as a non-volatile storage device to store program files of the operating system (OS) and applications, as well as data files used together with those programs. The HDD 103 writes and reads data on its internal magnetic platters in accordance with commands from the CPU 101. The node 11 may include a plurality of non-volatile storage devices such as solid state drives (SSD) in place of, or together with the HDD 103.

The video signal processing unit 104 produces video images in accordance with commands from the CPU 101 and outputs them on a screen of a display 42 coupled to the node 11. The display 42 may be, for example, a cathode ray tube (CRT) display or a liquid crystal display.

The input signal processing unit 105 receives input signals from input devices 43 and supplies them to the CPU 101. The input devices 43 may be, for example, a keyboard and a pointing device such as mouse and touchscreen.

The disk drive 106 is a device used to read programs and data stored in a storage medium 44. The storage medium 44 may include, for example, magnetic disk media such as flexible disk (FD) and HDD, optical disc media such as compact disc (CD) and digital versatile disc (DVD), and magneto-optical storage media such as magneto-optical disk (MO). The disk drive 106 transfers programs and data read out of the storage medium 44 to, for example, the RAM 102 or HDD 103 according to commands from the CPU 101.

The communication unit 107 is a network interface for the CPU 101 to communicate with other nodes 12 to 16 and client 31 (see FIG. 3) via a network 41. The communication unit 107 may be a wired network interface or a radio network interface.

The following section will now describe exhaustive joins executed by the information processing system according to the third embodiment. Exhaustive joins may sometimes be treated as a kind of simple joins.

Specifically, an exhaustive join acts on two given datasets A and B as seen in equation (1) below. One dataset A is a collection of m data elements a₁, a₂, . . . , aₘ, where m is a positive integer. The other dataset B is a collection of n data elements b₁, b₂, . . . , bₘ, where n is a positive integer. Preferably, each data element includes a unique identifier. That is, data elements are each formed from an identifier and a data value(s). As seen in equation (2) below, the exhaustive join yields a dataset by applying a map function to every ordered pair of a data element “a” in dataset A and a data element “b” in dataset B. The map function may return no output data elements or may output two or more resulting data elements, depending on the values of the arguments, a and b.

A={a₁,a₂, . . . , aₘ}

B={b₁,b₂, . . . , bₙ} (1)

x-join(A,B,map)={map(a,b)|(a,b)εA×B} (2)

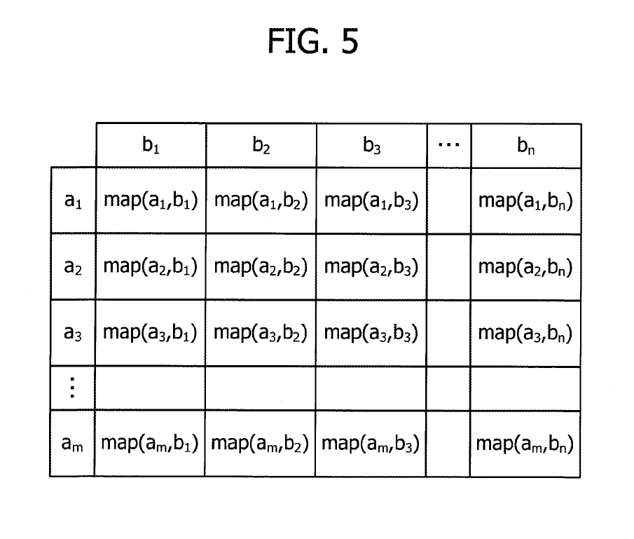

FIG. 5 illustrates an exhaustive join. As can seen from FIG. 5, an exhaustive join may be interpreted as an operation that applies a map function to the direct product between two datasets A and B. For example, the operation selects one data element a₁ from dataset A and another data element b₁ from dataset B and uses these data elements a₁ and b₁ as arguments of the map function. As mentioned above, function map(a₁, b₁) may not always return output values. That is, it is possible that the map function returns nothing when the data elements a₁ and b₁ do not satisfy a specific condition. Such operation of the map function is exerted on all of the (m×n) ordered pairs.

Exhaustive joins may be implemented as a software program using an algorithm known as “nested loop.” For example, an outer loop is configured to select one data element a from dataset A, and an inner loop is configured to select another data element b from dataset B. The inner loop repeats its operation by successively selecting n data elements b₁, b₂, . . . , bₙ in combination with a given data element aᵢ of dataset A. FIG. 5 depicts a plurality of such map operations. Since these operations are independent of each other, it is possible to parallelize the execution by allocating a plurality of nodes to them.

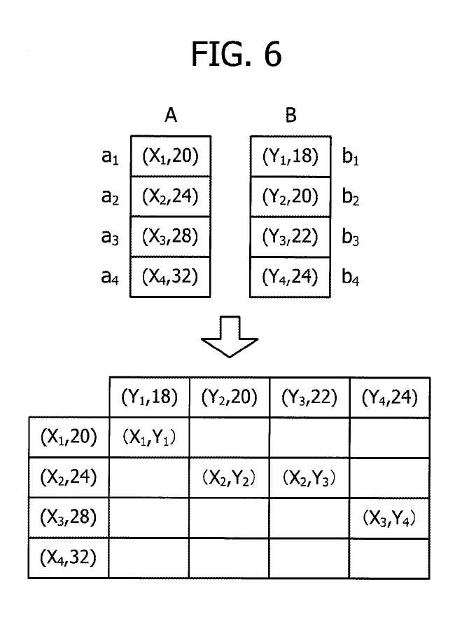

FIG. 6 illustrates an exemplary execution result of an exhaustive join. In this example of FIG. 6, dataset A includes four data elements a₁ to a₄, and dataset B includes four data elements b₁ to b₄. Each of these data elements of datasets A and B represents the name and age of a person.

In operation, the exhaustive join applies a map function to each of the sixteen ordered pairs organized in a 4×4 matrix. The map function in this example is, however, configured to return a result value on the conditions that (i) the age field of data element a has a greater value than that of data element b, and (ii) their difference in age is five or smaller. Because of these conditions, the map function returns a resulting data element for four ordered pairs (a₁, b₁), (a₂, b₂), (a₂, b₃), and (a₃, b₄) as seen in FIG. 6, but no outputs for the remaining ordered pairs.

Datasets may be provided in the form of, for example, tables as in a relational database, a set of (key, value) pairs in a key-value store, files, and matrixes. Data elements may be, for example, tuples of a table, pairs in a key-value store, records in a file, vectors in a matrix, and scalars.

An example of the above-described exhaustive join will now be described below. This example will handle a matrix as a set of vectors. Specifically, equation (3) represents a product of two matrixes A and B, where matrix A is treated as a set of row vectors, and matrix B as a set of column vectors. Equation (4) then indicates that matrix product AB is obtained by calculating an inner product for every possible combination of a row vector of matrix A and a column vector of matrix B. This means that matrix product AB is calculated as an exhaustive join of two sets of vectors.

$$\begin{matrix}A = ( \begin{matrix}{a}_{11} & {a}_{12} \\ {a}_{21} & {a}_{22}\end{matrix} ) = ( \begin{matrix}\vec{{a}_{1}} \\ \vec{{a}_{2}}\end{matrix} ) \\ B = ( \begin{matrix}{b}_{11} & {b}_{12} \\ {b}_{21} & {b}_{22}\end{matrix} ) = ( \begin{matrix}\vec{{b}_{1}} & \vec{{b}_{2}}\end{matrix} ) & ( 3 ) \\ AB = ( \begin{matrix}\vec{{a}_{1}} \\ \vec{{a}_{2}}\end{matrix} ) ( \begin{matrix}\vec{{b}_{1}} & \vec{{b}_{2}}\end{matrix} ) = ( \begin{matrix}\vec{{a}_{1}} \cdot \vec{{b}_{1}} & \vec{{a}_{1}} \cdot \vec{{b}_{2}} \\ \vec{{a}_{2}} \cdot \vec{{b}_{1}} & \vec{{a}_{2}} \cdot \vec{{b}_{2}}\end{matrix} ) & ( 4 )\end{matrix}$$

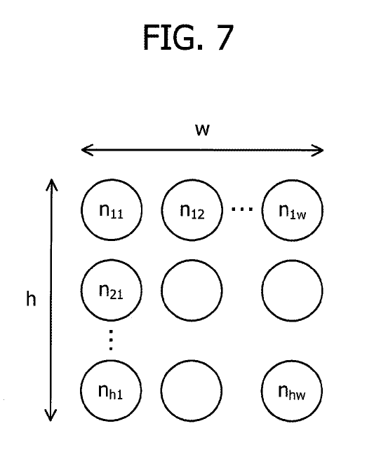

FIG. 7 illustrates a node coordination model according to the third embodiment. The exhaustive join of the third embodiment handles a plurality of participating nodes as if they are logically arranged in the form of a rectangular array. That is, the nodes are organized in an array with a height of h nodes and a width of w nodes. In other words, h represents the number of rows (or row dimension), and w represents the number of columns (or column dimension). The node sitting at the i-th row and j-th column is represented as nᵢⱼ in this model. As will be described below, the information processing system determines the row dimension h and the column dimension w when it starts data processing. The row dimension h may also be referred to as the number of vertical divisions. Similarly, the column dimension w may be referred to as the number of horizontal divisions.

At the start of parallel data processing, the data elements of datasets A and B are divided and assigned to a plurality of nodes logically arranged in a rectangular array. Each node receives and stores data elements in a data storage device, which may be a semiconductor memory (e.g., RAM 102) or a disk drive (e.g., HDD 103). This initial assignment of datasets A and B is executed in such a way that the nodes will receive as equal amounts of data as possible. This policy is referred to as the evenness. The assignment of datasets A and B is also executed in such a way that a single data element will never be assigned to two or more nodes. This policy is referred to as the uniqueness.

Assuming that both the evenness and uniqueness policies are perfectly applied, each node nᵢⱼ obtains subsets Aᵢⱼ and Bᵢⱼ of datasets A and B as seen in equation (5). The number of data elements included in a subset Aᵢⱼ is calculated by dividing the total number of data elements of dataset A by the total number N of nodes (N=h×w). Similarly, the number of data elements included in a subset Bᵢⱼ is calculated by dividing the total number of data elements of dataset B by the total number N of nodes.

$$\begin{matrix}A = {\sum }_{i = 1}^{h} {\sum }_{j = 1}^{w} {A}_{ij} & \vert {A}_{ij} \vert = \frac{\vert A \vert}{N} \\ B = {\sum }_{i = 1}^{h} {\sum }_{j = 1}^{w} {B}_{ij} & \vert {B}_{ij} \vert = \frac{\vert B \vert}{N}\end{matrix} \qquad ( 5 )$$

Row subset Aᵢ of dataset A is now defined as the union of subsets Aᵢ₁, Aᵢ₂, . . . , A_{iw} assigned to nodes nᵢ₁, nᵢ₂, . . . , n_{iw} having the same row number. Likewise, column subset Bⱼ is defined as the union of subsets B₁ⱼ, B₂ⱼ, . . . , Bₕⱼ assigned to nodes n₁ⱼ, n₂ⱼ, . . . , nₕⱼ having the same column number. As seen from equation (6), dataset A is a union of h row subsets Aᵢ, and dataset B is a union of w column subsets Bⱼ.

$$A = {\sum }_{i = 1}^{h} {A}_{i} \\ B = {\sum }_{j = 1}^{w} {B}_{j} \qquad ( 6 )$$

The exhaustive join of two datasets A and B may now be rewritten by using their row subsets Aᵢ and column subsets Bⱼ. That is, this exhaustive join is divided into h×w exhaustive joins as seen in equation (7) below. Here each node nᵢⱼ may be configured to execute an exhaustive join of one row subset Aᵢ and one column subset Bⱼ. The original exhaustive join of two datasets A and B is then calculated by running the computation in those h×w nodes in parallel. Initially the data elements of datasets A and B are distributed to the nodes under the evenness and uniqueness policies mentioned above. The node nᵢⱼ in this condition then receives subsets of dataset A from other nodes with the same row number i, as well as subsets of dataset B from other nodes with the same column number j.

$$\begin{matrix}x \text{-} join ( A , B , map ) = {\sum }_{i = 1}^{h} {\sum }_{j = 1}^{w} \{ map ( a , b ) \vert ( a , b ) ∈ {A}_{i} \times {B}_{j} \} \\ = {\sum }_{i = 1}^{h} {\sum }_{j = 1}^{w} x \text{-} join ( {A}_{i} , {B}_{j} , map )\end{matrix} \qquad ( 7 )$$

As described above, data elements have to be duplicated from node to node before each node begins an exhaustive join locally with its own set of data elements. The information processing system therefore determines the optimal row dimension h and optimal column dimension w to minimize the amount of data transmitted among N nodes deployed for distributed execution of exhaustive joins.

The amount c of data transmitted or received by each node is calculated according to equation (8), assuming that subsets of dataset A are relayed in the row direction whereas subsets of dataset B are relayed in the column direction. For simplification of the mathematical model and algorithm, it is also assumed that each node receives data elements not only from other nodes, but also from itself. The amount c of transmit data (=the amount of receive data) is added up for N nodes, thus obtaining the total amount C of transmit data as seen in equation (9). More specifically, the total amount C of transmit data is a function of the row dimension h, when the number N of nodes and the number of data elements of each dataset A and B are given.

$$\begin{matrix}c = w \vert {A}_{ij} \vert + h \vert {B}_{ij} \vert = w \frac{\vert A \vert}{N} + h \frac{\vert B \vert}{N} & ( 8 ) \\ C = Nc = w \vert A \vert + h \vert B \vert = \frac{N \vert A \vert}{h} + h \vert B \vert & ( 9 )\end{matrix}$$

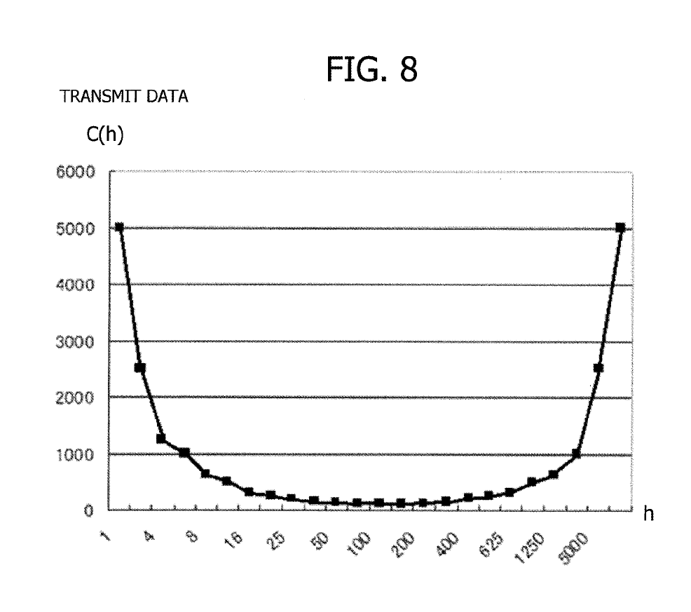

FIG. 8 gives a graph illustrating how the amount of transmit data varies with the row dimension h of nodes. The graph of FIG. 8 plots the values calculated on the assumptions that 10000 nodes are configured to process datasets A and B each containing 10000 data elements. The illustrated curve of total amount C hits its minimum point when h=100. The row dimension h at this minimum point of C is calculated by differentiating equation (9). The solution is seen in equation (10). It is noted that the row dimension practically has to be a divisor of N. For this reason, the value of h is determined as follows: (a) h=1 when equation (10) yields a value of one or zero, (b) h=N when equation (10) yields a value of N or more, and (c) h is otherwise set to a divisor of N that is closest to the value of equation (10) below. In the last case (c), there may be two closest divisors (i.e., one is greater than and the other is smaller than the calculated value). When this is the case, h is set to the one that minimizes the total amount C of transmit data.

The total number N of nodes is previously determined on the basis of, for example, the number of available nodes, the amount of data to be processed, and the response time that the system is supposed to achieve. Preferably, the total number N of nodes has many divisors since the above parameter h is selected from among those divisors of N. For example, N may be a power of 2. It is not preferable to select prime numbers or other numbers having few divisors. If the predetermined value of N does not satisfy this condition, N may be changed to a smaller number having many divisors. For example, a new integer number of N may be a power of 2 that is the largest in the range below N.

$$h = \sqrt{\frac{\vert A \vert}{\vert B \vert} N} \qquad ( 10 )$$

The following section will now describe how to relay data elements from node to node. While the description assumes that data elements are passed along in the row direction, the person skilled in the art would appreciate that the same method applies also to the column direction.

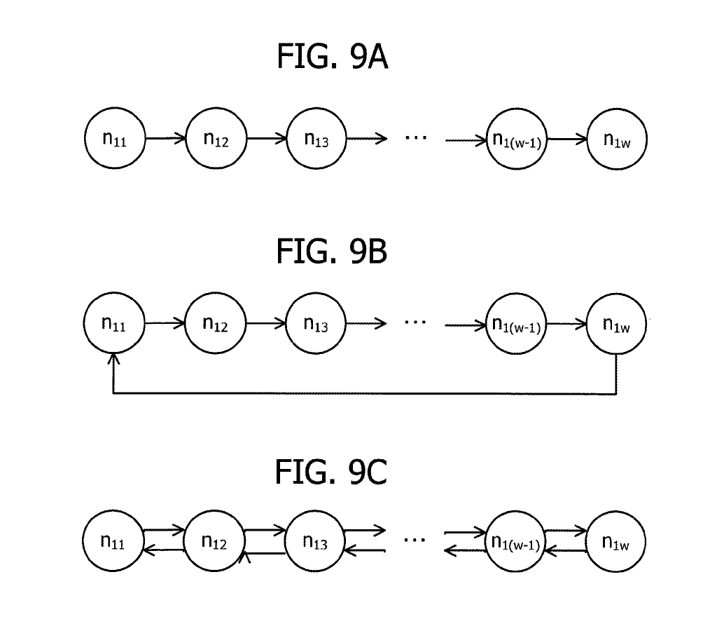

FIGS. 9A, 9B, and 9C illustrate three methods for the nodes to relay their data. Referring first to method A illustrated in FIG. 9A, the leftmost node n₁₁ sends a subset A₁₁ to the second node n₁₂ in order to propagate its assigned data to other nodes n₁₂, . . . , n_{1w}. The second node n₁₂ then duplicates the received subset A₁₁ to the third node n₁₃. Similarly the subset A₁₁ is transferred rightward until it reaches the rightmost node n_{1w}. Other subsets initially assigned to the intermediate nodes may also be relayed rightward in the same way. According to this method A, the originating node does not need to establish connections with every receiving node, but has only to set up a connection to the next node, because data elements are relayed by a repetition of such a single connection between two adjacent nodes. This nature of method A contributes to a reduced load of communication. The method A is, however, unable to duplicate data elements in the leftward direction.

Referring next to method B illustrated in FIG. 9B, the rightmost node n_{1w} establishes a connection back to the leftmost node n₁₁, thus forming a circular path of data. Each nodes nᵢⱼ transmits its initially assigned subset Aᵢⱼ to the right node, thereby propagating a copy of subset Aᵢⱼ to other nodes on the same row. Each data element bares an identifier (e.g., address or coordinates) of the source node so as to prevent the data elements from circulating endlessly on the path.

Referring lastly to method C illustrated in FIG. 9C, the nodes establish a rightward connection from the leftmost node n₁₁ to the rightmost node n_{1w} and a leftward connection from the rightmost node n_{1w} to the leftmost node n₁₁. For example, the leftmost node n₁₁ sends its subset A₁₁ to the right node. The rightmost node n_{1w}, on the other hand, sends its subset A_{1w} to the left node. Intervening nodes nᵢⱼ send their respective subsets Aᵢⱼ to both their right and left nodes. This method C may be modified to form a circular path as in method B.

The third embodiment preferably uses method B or method C to relay data for the purpose of exhaustive joins. As an alternative method, data elements may be duplicated by broadcasting them in a broadcast domain of the network. This method is applicable when the sending node and receiving nodes belong to the same broadcast domain. The foregoing equation (10) may similarly be used in this case to calculate the optimal row dimension h, taking into account the total amount of receive data.

When data elements are sent from a first node to a second node, the second node sends a response message such as acknowledgment (ACK) or negative acknowledgment (NACK) back to the first node. In the case where the second node has some data elements to send later to the first node, the second node may send the response message not immediately, but together with those data elements.

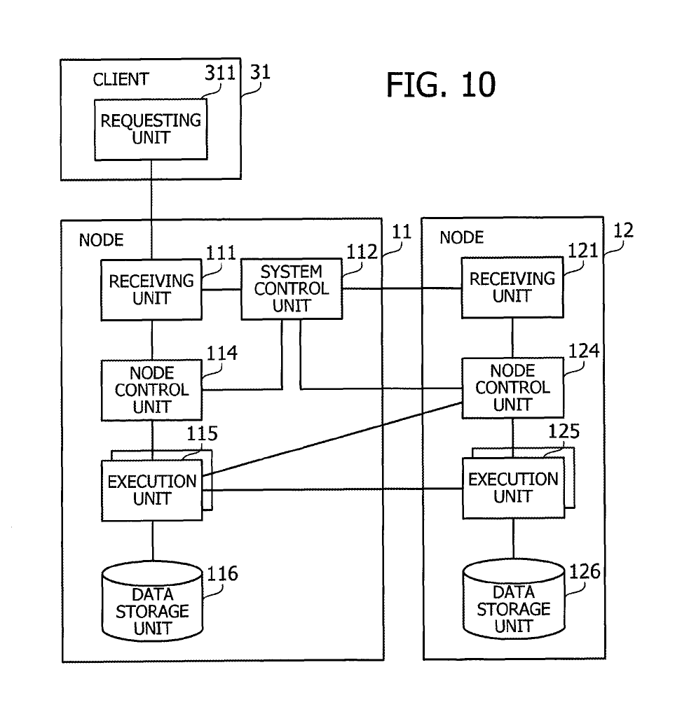

FIG. 10 is a block diagram illustrating an exemplary software structure according to the third embodiment. This block diagram includes a client 31 and two nodes 11 and 12. The former node 11 includes a receiving unit 111, a system control unit 112, a node control unit 114, an execution unit(s) 115, and a data storage unit 116. This block structure of the node 11 may also be used to implement other nodes 12 to 16. For example, the illustrated node 12 includes a receiving unit 121, a node control unit 124, an execution unit(s) 125, a data storage unit 126, and a system control unit (omitted in FIG. 10). FIG. 10 also depicts a client 31 with a requesting unit 311. The data storage units 116 and 126 may be implemented as reserved storage areas of RAM or HDD, while the other blocks may be implemented as program modules.

The client 31 includes a requesting unit 311 that sends a command in response to a user input to start data processing. This command is addressed to the node 11 in FIG. 10, but may alternatively be addressed to any of the other nodes 12 to 16.

The receiving unit 111 in the node 11 receives commands from a client 31 or other nodes. The computer process implementing this receiving unit 111 is always running on the node 11. When a command is received from the client 31, the receiving unit 111 calls up its local system control unit 112. Further, when a command is received from the system control unit 112, the receiving unit 111 calls up its local node control unit 114. The receiving unit 111 in the node 11 may also receive a command from a peer node when its system control unit is activated. In response, the receiving unit 111 calls up the node control unit 114 to handle that command. The node knows the addresses (e.g., Internet Protocol (IP) addresses) of receiving units in other nodes.

The system control unit 112 controls overall transactions during execution of exhaustive joins. The computer process implementing this system control unit 112 is activated upon call from the receiving unit 111. Each time a specific data processing operation (or transaction) is requested from the client 31, one of the plurality of nodes activates its system control unit. The system control unit 112, when activated, transmits a command to the receiving unit (e.g., receiving units 111 and 121) of nodes to invite them to participate in the execution of the requested exhaustive join. This command calls up the node control units 114 and 124 in the nodes 11 and 12.

The system control unit 112 also identifies logical connections between the nodes and sends a relaying command to the node control unit (e.g., node control unit 114) of a node that is supposed to be the source point of data elements. This relaying command contains information indicating which nodes are to relay data elements. When the duplication of data elements is finished, the system control unit 112 issues a joining command to execute an exhaustive join to the node control units of all the participating nodes (e.g., node control units 114 and 124 in FIG. 10). When the exhaustive join is finished, the system control unit 112 so notifies the client 31.

The node control unit 114 controls information processing tasks that the node 11 undertakes as part of an exhaustive join. The computer process implementing this node control unit 114 is activated upon call from the receiving unit 111. The node control unit 114 calls up the execution unit 115 when a relaying command or joining command is received from the system control unit 112. Relaying commands and joining commands may come also from a peer node (or more specifically, from its system control unit that is activated). The node control unit 114 similarly calls up its local execution unit 115 in response. The node control unit 114 may also call up its local execution unit 115 when a reception command is received from a remote execution unit of a peer node.

The execution unit 115 performs information processing operations requested from the node control unit 114. The computer process implementing this execution unit 115 is activated upon call from the node control unit 114. The node 11 is capable of invoking a plurality of processes of the execution unit 115. In other words, it is possible to execute multiple processing operations at the same time, such as relaying dataset A in parallel with dataset B. This feature of the node 11 works well in the case where the node 11 has a plurality of processors or a multiple-core processor.

When called up in connection with a relaying command, the execution unit 115 transmits a reception command to the node control unit of an adjacent node (e.g., node control unit 124 in FIG. 10). In response, the adjacent node makes its local execution unit (e.g., execution unit 125) ready for receiving data elements. The execution unit 115 then reads out assigned data elements of the node 11 from the data storage unit 116 and transmits them to its counterpart in the adjacent node.

When called up in connection with a reception command, the execution unit 115 receives data elements from its counterpart in a peer node and stores them in its local data storage unit 116. The execution unit 115 also forwards these data elements to the next node unless the node 11 is their final destination, as in the case of relaying commands. When called up in connection with a joining command, the execution unit 115 locally executes an exhaustive join with its own data elements in the data storage unit 116 and writes the result back into the data storage unit 116.

The data storage unit 116 stores some of the data elements constituting datasets A and B. The data storage unit 116 initially stores data elements belonging to subsets A₁₁ and B₁₁ that are assigned to the node 11 in the first place. Then subsequent relaying of data elements causes the data storage unit 116 to receive additional data elements belonging to a row subset A₁ and a column subset B₁. Similarly, the data storage unit 126 in the node 12 stores some data elements of datasets A and B.

Generally, when a first module sends a command to a second module, the second module performs requested information processing and then notifies the first module of completion of that command. For example, the execution unit 115 notifies the node control unit 114 upon completion of its local exhaustive join. The node control unit 114 then notifies the system control unit 112 of the completion. When such completion notice is received from every node participating in the exhaustive join, the system control unit 112 notifies the client 31 of completion of its request.

The above-described system control unit 112, node control unit 114, and execution unit 115 may be implemented as, for example, a three-tier internal structure made up of a command parser, optimizer, and code executor. Specifically, the command parser interprets the character string of a received command and produces an analysis tree representing the result. Based on this analysis tree, the optimizer generates (or selects) optimal intermediate code for execution of the requested information processing operation. The code executor then executes the generated intermediate code.

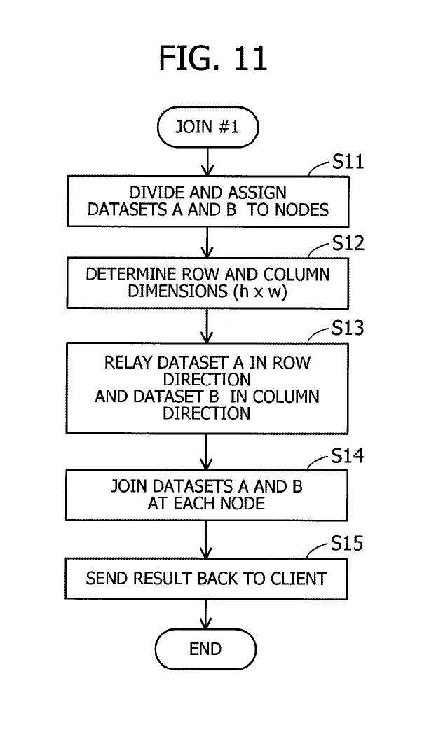

FIG. 11 is a flowchart illustrating an exemplary procedure of joins according to the third embodiment. As previously mentioned, the number N of participating nodes may be determined by the system control unit 112 before the process starts with step S11, based on the total number of nodes in the system. Each step of the flowchart will be described below.

(S11) The client 31 has specified datasets A and B as input data for an exhaustive join. The system control unit 112 divides those two datasets A and B into N subsets Aᵢⱼ and N subsets Bᵢⱼ, respectively, and assigns them to a plurality of nodes 11 to 16. As an alternative, the nodes 11 to 16 may assign datasets A and B to themselves according to a request from the client 31 before the node 11 receives a start command for data processing. As another alternative, the datasets A and B may be given as an output of previous data processing at the nodes 11 to 16. In this case, the system control unit 112 may find that the assignment of datasets A and B has already been finished.

(S12) The system control unit 112 determines the row dimension h and column dimension w by using a calculation method such as equation (10) discussed above, based on the number N of participating nodes (i.e., nodes used to executed the exhaustive join), and the number of data elements of each given dataset A and B.

(S13) The system control unit 112 commands the nodes 11 to 16 to duplicate their respective subsets Aᵢⱼ in the row direction, as well as duplicate subsets Bᵢⱼ in the column direction. The execution unit in each node relays subsets Aᵢⱼ and Bᵢⱼ in their respective directions. The above relaying may be achieved by using, for example, the method B or C discussed in FIGS. 9B and 9C. The above duplication of subsets permits each node nᵢⱼ to obtain row subset Aᵢ and column subset Bⱼ.

(S14) The system control unit 112 commands all the participating nodes 11 to 16 to locally execute an exhaustive join. In response, the execution unit in each node executes an exhaustive join locally (i.e., without communicating with other nodes) with the row subset Aᵢ and column subset Bⱼ obtained at step S13. The execution unit stores the result in a relevant data storage unit. Such local exhaustive joins may be implemented in the form of a nested loop, for example.

(S15) The system control unit 112 sees that every participating node 11 to 16 has finished step S14, thus notifying the requesting client 31 of completion of the requested exhaustive join. The system control unit 112 may also collect result data from the data storage units of nodes and send it back to the client 31. Or alternatively, the system control unit 112 may allow the result data to stay in the nodes, so that the subsequent data processing can use it as input data. It may be possible in the latter case to skip the step of assigning initial data elements to participating nodes.

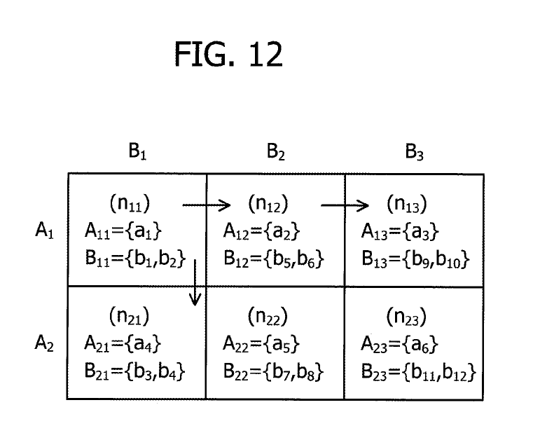

FIG. 12 illustrates a first diagram illustrating an exemplary data arrangement according to the third embodiment. This example assumes that six nodes n₁₁, n₁₂, n₁₃, n₂₁, n₂₂, and n₂₃ (11 to 16) are configured to execute an exhaustive join of datasets A and B. Dataset A is formed from six data elements a₁ to a₆, while dataset B is formed from twelve data elements b₁ to b₁₂. Each node nᵢⱼ is equally assigned one data element from dataset A and two data elements from dataset B. In other words, the former is subset Aᵢⱼ, and the latter is subset Bᵢⱼ. For example, node n₁₁ receives the following two subsets: A₁₁={a₁} and B₁₁={b₁, b₂}. Here the number N of participating nodes is six. As dataset A includes six data elements, and dataset B includes twelve data elements, the foregoing equation (10) gives h=2 for the row dimension.

Upon determination of row dimension h and column dimension w, each subset Aᵢⱼ is duplicated by the nodes having the same row number (i.e., in the row direction), and each subset Bᵢⱼ is duplicated by the nodes having the same column number (i.e., in the column direction). For example, subset A₁₁ assigned to node n₁₁ is copied from node n₁₁ to node n₁₂, and then from node n₁₂ to node n₁₃. Subset B₁₁ assigned to node n₁₁ is copied from node n₁₁ to node n₂₁.

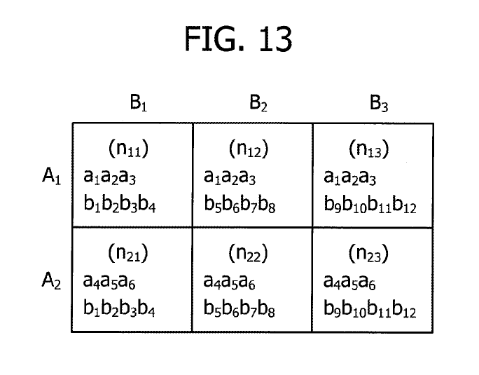

FIG. 13 is a second diagram illustrating an exemplary data arrangement according to the third embodiment. As a result of the above duplication of data elements, each node nᵢⱼ now contains a row subset Aᵢ and a column subset Bⱼ in their entirety. For example, nodes n₁₁, n₁₂, and n₁₃ have obtained a row subset A₁={a₁, a₂, a₃}, and nodes n₁₁ and n₂₁ have obtained a column subset B₁={b₁, b₂, b₃, b₄}.

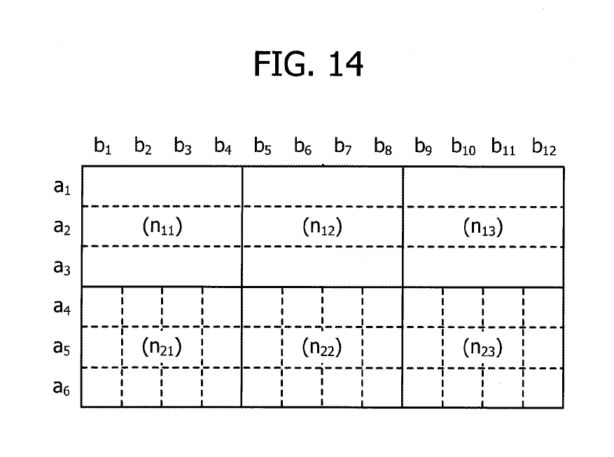

FIG. 14 is a third diagram illustrating an exemplary data arrangement according to the third embodiment. Each node nᵢⱼ locally executes an exhaustive join with the above row subset Aᵢ and column subset Bⱼ. For example, node n₁₁ selects one data element a from row subset A1={a₁, a₂, a₃} and one element b from column subset B1={b₁, b₂, b₃, b₄} and subjects these two data elements to the map function. By repeating this operation, node n₁₁ applies the map function to all the twelve ordered pairs (i.e., 3×4 combinations) of data elements. As seen in FIG. 14, six nodes n₁₁, n₁₂, n₁₃, n₂₁, n₂₂, and n₂₃ equally process twelve different ordered pairs. These six nodes as a whole cover all the 72 (=6×12) ordered pairs produced from datasets A and B, without redundant duplication.

The proposed information processing system of the third embodiment executes an exhaustive join of datasets A and B efficiently by using a plurality of nodes. Particularly, the system starts execution of an exhaustive join with the initial subsets of datasets A and B that are assigned evenly (or near evenly) to a plurality of participating nodes without redundant duplication. The nodes are equally (or near equally) loaded with data processing operations with no needless duplication. For these reasons, the third embodiment enables scalable execution of exhaustive joins (where overhead of communication is neglected). That is, the processing time of an exhaustive join decreases to 1/N when the number of nodes is multiplied N-fold.

### (d) Fourth Embodiment

This section describes a fourth embodiment with the focus on its differences from the third embodiment. For their common elements and features, see the previous description of the third embodiment. To execute exhaustive joins, the fourth embodiment uses a large-scale information processing system formed from a plurality of communication devices interconnected in a hierarchical way.

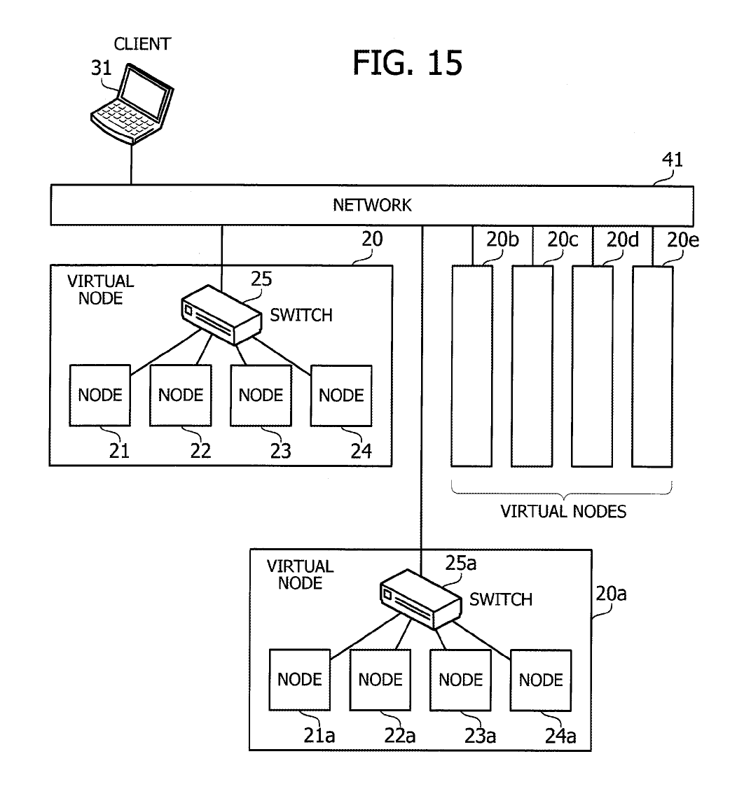

FIG. 15 illustrates an information processing system according to the fourth embodiment. The illustrated information processing system includes virtual nodes 20, 20a, 20b, 20c, 20d, and 20e, a client 31, and a network 41.

Each virtual node 20, 20a, 20b, 20c, 20d, and 20e includes at least one switch (e.g., layer-2 switch) and a plurality of nodes linked to that switch. For example, one virtual node 20 includes four nodes 21 to 24 and a switch 25. Another virtual node 20a includes four nodes 21a to 24a and a switch 25a. Each such virtual node may be handled logically as a single node when the system executes exhaustive joins.

The above six virtual nodes are equal in the number of nodes that they include. The number of constituent nodes has been determined in consideration of their connection with a communication device and the like. However, this number of constituent nodes may not necessarily be the same as the number of nodes that participate in a particular data processing operation. As discussed in the third embodiment, the latter number may be determined in such a way that the number of nodes will have as many divisors as possible. The constituent nodes of a virtual node are associated one-to-one with those of another virtual node. Such one-to-one associations are found between, for example, nodes 21 and 21a, nodes 22 and 22a, nodes 23 and 23a, and nodes 24 and 24a. While FIG. 15 illustrates an example of virtualization into a single layer, it is also possible to build a multiple-layer structure of virtual nodes such that one virtual node includes other virtual nodes.

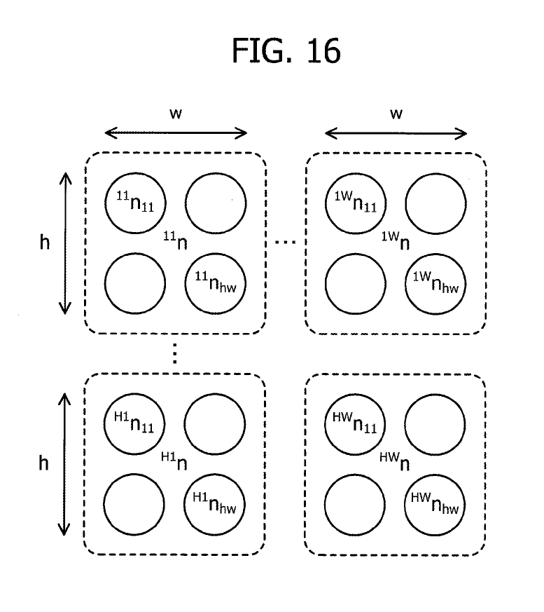

FIG. 16 illustrates a node coordination model according to the fourth embodiment. To execute an exhaustive join, the fourth embodiment handles a plurality of virtual nodes as if they are logically arranged in the form of a rectangular array. That is, the virtual nodes are organized in an array with a height of H virtual nodes and a width of W virtual nodes. In other words, H represents the number of rows (or row dimension), and W represents the number of columns (or column dimension). The row dimension H and column dimension W are determined from the number of virtual nodes and the number of data elements constituting each dataset A and B, similarly to the way described in the previous embodiments. Further, in each virtual node, its constituent nodes are logically organized in an array with a height of h nodes and a width of w nodes. The row dimension h and column dimension w are determined as common parameters that are applied to all virtual nodes. Specifically, the dimensions h and w are determined from the number of nodes per virtual node and the number of data elements constituting each dataset A and B.

The virtual node at the i-th row and j-th column is represented as ^{ij}n in the illustrated model, where the superscript indicates the coordinates of the virtual node. Within a virtual node ^{ij}n, the node at the i-th row and j-th column is represented as where the subscript indicates the coordinates of the node. At the start of an exhaustive join, the system assigns datasets A and B to all nodes n₁₁, . . . , n_{hw} included in all participating virtual nodes ¹¹n, . . . , ^{HW}n. That is, the data elements are distributed evenly (or near evenly) across the nodes without redundant duplication.

The data elements initially assigned above are then duplicated from virtual node to virtual node via two or more different intervening switches. Subsequently the data elements are duplicated within each closed domain of the virtual nodes. There is a recursive relationship between the data duplication among virtual nodes and the data duplication within a virtual node. Specifically, subsets of dataset A are duplicated across virtual nodes with the same row number, while subsets of dataset B are duplicated across virtual nodes with the same column number. Then within each virtual node, subsets of dataset A are duplicated across nodes with the same row number, while subsets of dataset B are duplicated across nodes with the same column number. Communication between two virtual nodes is implemented as communication between “associated nodes” (or nodes at corresponding relative positions) in the two. For example, when duplicating data elements from virtual node ¹¹n to virtual node ¹²n, this duplication actually takes place from node ¹¹n₁₁ to node ¹²n₁₁, from node ¹¹n₁₂ to node ¹²n₁₂, and so on. There are no interactions between non-associated nodes.

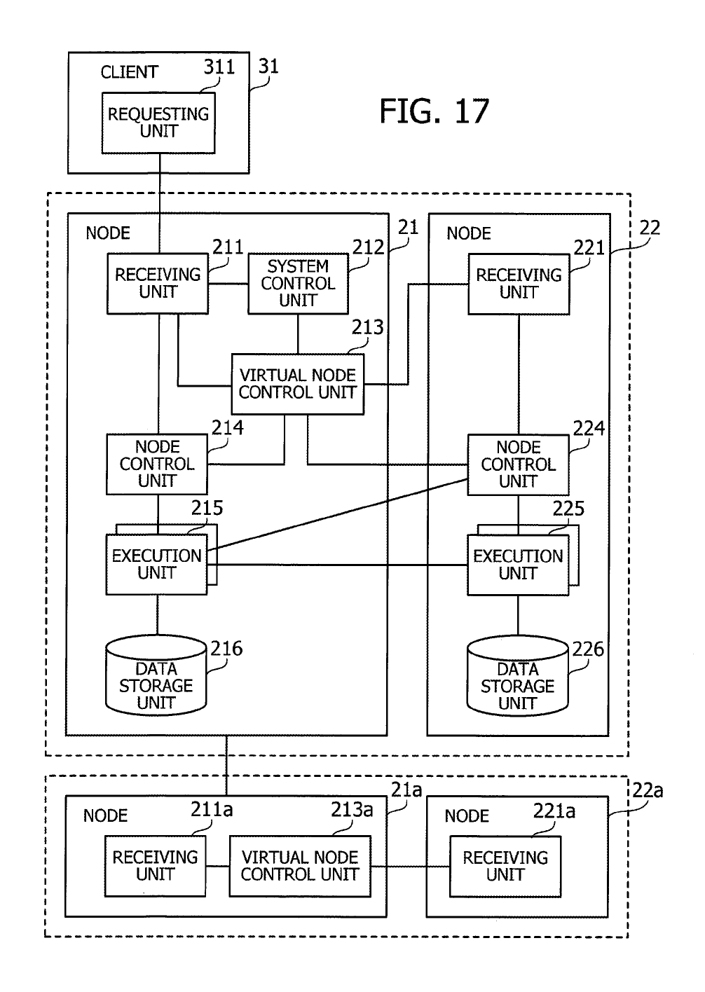

FIG. 17 is a block diagram illustrating an exemplary software structure according to the fourth embodiment. The illustrated node 21 includes a receiving unit 211, a system control unit 212, a virtual node control unit 213, a node control unit 214, an execution unit(s) 215, and a data storage unit 216. This block structure of the node 12 may also be used to implement other nodes, including nodes 22 to 24 and nodes 21a to 24a in FIG. 15. For example, another node 22 illustrated in FIG. 17 includes a receiving unit 221, a node control unit 224, an execution unit(s) 225, and a data storage unit 226. While not explicitly depicted, this node 22 further includes its own system control unit and virtual node control unit. Yet another node 21a illustrated in FIG. 17 includes a receiving unit 211a and a virtual node control unit 213a. While not explicitly depicted, this node 21a further includes its own system control unit, node control unit, execution unit(s), and data storage unit. Still another node 22a illustrated in FIG. 17 include a receiving unit 221a. While not explicitly depicted, this node 22a further includes its own system control unit, virtual node control unit, node control unit, execution unit(s), and data storage unit. As in the foregoing third embodiment, the data storage units 216 and 226 may be implemented as reserved storage areas of RAM or HDD, while the other blocks may be implemented as program modules.

The following description assumes that the node 21 is supposed to coordinate execution of data processing requests from a client 31. It is also assumed that the node 21 controls the virtual node 20 to which the node 21 belongs, and that the node 21a controls the virtual node 20a to which the node 21a belongs.

The receiving unit 211 receives commands from a client 31 or other nodes. The computer process implementing this receiving unit 211 is always running on the node 21. When a command is received from the client 31, the receiving unit 211 calls up its local system control unit 212. When a command is received from the system control unit 212, the receiving unit 211 calls up its local virtual node control unit 213 in response. Further, when a command is received from the virtual node control unit 213, the receiving unit 211 calls up its local virtual node control unit 214 in response. The receiving unit 211 in the node 21 may also receive a command from a peer node when its system control unit is activated. In response, the receiving unit 211 calls up the virtual node control unit 213 to handle that command. Further, the receiving unit 211 may receive a command from a peer node when its virtual node control unit is activated. In response, the receiving unit 211 calls up the node control unit 214 to handle that command.

The system control unit 212 controls a plurality of virtual nodes as a whole when they are used to execute in an exhaustive join. Each time a specific data processing operation (or transaction) is requested from the client 31, only one of those nodes activates its system control unit. Upon activation, the system control unit 212 issues a query to a predetermined node (representative node) in each virtual node to request information about which node will be responsible for the control of that virtual node. The node in question is referred to as a “deputy node.” The deputy node is chosen on a per-transaction basis so that the participating nodes share their processing load of an exhaustive join. The system control unit 212 then transmits a deputy designating command to the receiving unit of the deputy node in each virtual node. For example, this command causes the node 21 to call up its virtual node control unit 213, as well as causing the node 21a to call up its virtual node control unit 213a.

Subsequent to the deputy designating command, the system control unit 212 transmits a participation request command to the virtual node control unit in each virtual node (e.g., virtual node control units 213 and 213a). The system control unit 212 further determines logical connections among the virtual nodes, as well as among their constituent nodes, and transmits a relaying command to the virtual node control unit in each virtual node. When the duplication of data elements is finished, the system control unit 212 transmits a joining command to the virtual node control unit in each virtual node. When the exhaustive join is finished, the system control unit 212 so notifies the client 31.

The virtual node control unit 213 controls a plurality of nodes 21 to 24 belonging to the virtual node 20. The computer process implementing this virtual node control unit 213 is activated upon call from the receiving unit 211. Each time a specific data processing operation (or transaction) is requested from the client 31, only one constituent node in each virtual node activates its virtual node control unit. The activated virtual node control unit 213 may receive a participation request command from the system control unit 212. When this is the case, the virtual node control unit 213 forwards the command to the receiving unit of each participating node within the virtual node 20. For example, the receiving units 211 and 221 receive this participation request command, which causes the node 21 to call up its node control unit 214 and the node 22 to call up its node control unit 224.

The virtual node control unit 213 may also receive a relaying command from the system control unit 212. The virtual node control unit 213 forwards this command to the node control unit (e.g., node control unit 214) of a particular node that is supposed to be the source point of data elements to be relayed. The virtual node control unit 213 may further receive a joining command from the system control unit 212. The virtual node control unit 213 forwards the command to the node control unit of each participating node within the virtual node 20. For example, the node control units 214 and 224 receive this participation request command.

The node control unit 214 controls information processing tasks that the node 21 undertakes as part of an exhaustive join. The computer process implementing this node control unit 214 is activated upon call from the receiving unit 211. The node control unit 214 calls up the execution unit 215 when a relaying command or joining command is received from the virtual node control unit 213. Relaying commands and joining commands may come also from a peer node of the node 21 (or more specifically, from the virtual node control unit activated in a peer node). The node control unit 214 similarly calls up its local execution unit 215 in response. The node control unit 214 may also call up its local execution unit 215 when a reception command is received from a remote execution unit of a peer node.

The execution unit 215 performs information processing operations requested from the node control unit 214. The computer process implementing this execution unit 215 is activated upon call from the node control unit 214. The node 21 is capable of invoking a plurality of processes of the execution unit 215. When called up in connection with a relaying command, the execution unit 215 transmits a reception command to the node control unit of a peer node (e.g., node control unit 224 in node 21). The execution unit 215 then reads data elements out of the data storage unit 216 and transmits them to its counterpart in the adjacent node (e.g., execution unit 225).

When called up in connection with a reception command, the execution unit 215 receives data elements from its counterpart in a peer node and stores them in its local data storage unit 216. The execution unit 215 forwards these data elements to another node unless the node 21 is not their final destination. Further, when called up in connection with a joining command, the execution unit 215 locally executes an exhaustive join with the collected data elements and writes the result back into the data storage unit 216.

The data storage unit 216 stores some of the data elements constituting datasets A and B. The data storage unit 116 initially stores data elements that belong to some subsets assigned to the node 21 in the first place. Then subsequent relaying of data elements, both between virtual nodes and within a single virtual node 20, causes the data storage unit 216 to receive additional data elements belonging to relevant row and column subsets. Similarly, the data storage unit 226 in the node 22 stores some data elements of datasets A and B.

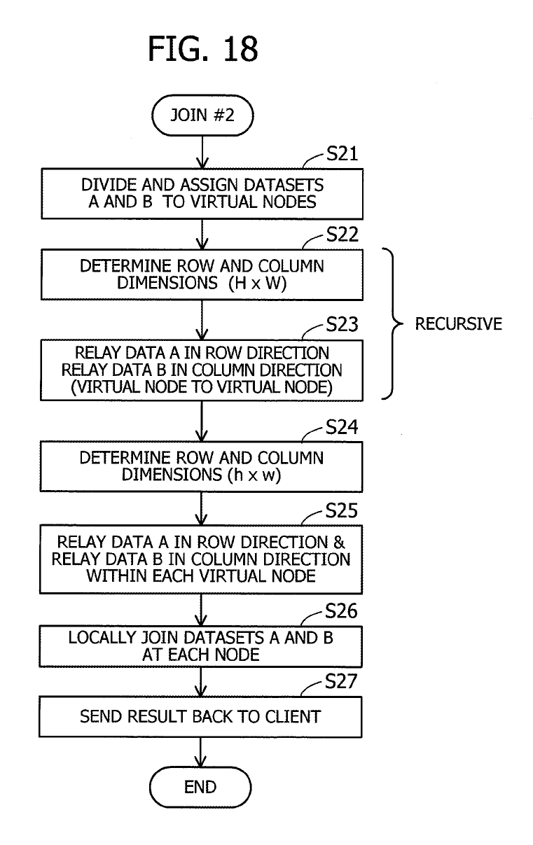

FIG. 18 is a flowchart illustrating an exemplary procedure of joins according to the fourth embodiment. As previously mentioned, the number N of participating nodes may be determined by the system control unit 212 before the process starts with step S21, based on the total number of nodes in the system. Each step of the flowchart will be described below.

(S21) The client 31 has specified datasets A and B as input data for an exhaustive join. The system control unit 212 divides those two datasets A and B into as many subsets as the number of participating virtual nodes, and assigns them to those virtual nodes. Then in each virtual node, the virtual node control unit subdivides the assigned subset into as many smaller subsets as the number of participating nodes in that virtual node and assigns the divided subsets to those nodes. The input datasets A and B are distributed to a plurality of nodes as a result of the above operation. As an alternative, the assignment of datasets A and B may be performed upon request from the client 31 before the node receives a start command for data processing. As another alternative, the datasets A and B may be given as an output of previous data processing at these nodes. In this case, the system control unit 212 may find that datasets A and B have already been distributed to relevant nodes.

(S22) The system control unit 212 determines the row dimension H and column dimension W by using a calculation method such as equation (10) described previously, based on the number N of participating virtual nodes and the number of data elements of each given dataset A and B.

(S23) The system control unit 212 commands the deputy node of each virtual node to duplicate data elements among the virtual nodes. The virtual node control unit in the deputy node then commands each node within the virtual node to duplicate data elements to other virtual nodes. The execution units in such nodes relay the subsets of dataset A in the row direction by communicating with their associated nodes in other virtual nodes sharing the same row number. These execution units also relay the subsets of dataset B in the column direction by communicating with their associated nodes in other virtual nodes sharing the same column number.

Steps S22 and S23 may be executed recursively in the case where the virtual nodes are nested in a multiple-layer structure. This recursive operation may be implemented by causing the virtual node control unit to inherit the above-described role of the system control unit 212. The same may apply to step S21.

(S24) The system control unit 212 determines the row dimension h and column dimension w by using a calculation method such as equation (10) described previously, based on the number of participating nodes per virtual node and the number of data elements per virtual node at that moment.

(S25) The system control unit 212 commands the deputy node of each virtual node to duplicate data elements within that virtual node. The virtual node control unit in the deputy node then commands the nodes constituting the virtual node to duplicate their data elements to each other. The execution unit in each constituent node transmits subsets of dataset A in the row direction, which include the one initially assigned thereto and those received from other virtual nodes at step S23. The execution unit in each constituent node also transmits subsets of dataset B in the column direction, which include the one initially assigned thereto and those received from other virtual nodes at step S23.

(S26) The system control unit 212 commands the deputy node in each virtual node to locally execute an exhaustive join. In the deputy nodes, their virtual node control unit commands relevant nodes in each virtual node to locally execute an exhaustive join. The execution unit in each node locally executes an exhaustive join between the row and column subsets collected through the processing of steps S23 and S25, thus writing the result in the data storage unit in the node.

(S27) Upon completion of the data processing of step S26 at every participating node, the system control unit 212 notifies the client 31 of completion of the requested exhaustive join. The system control unit 212 may further collect result data from the data storage units of nodes and send it back to the client 31. Or alternatively, the system control unit 112 may allow the result data to stay in the nodes.

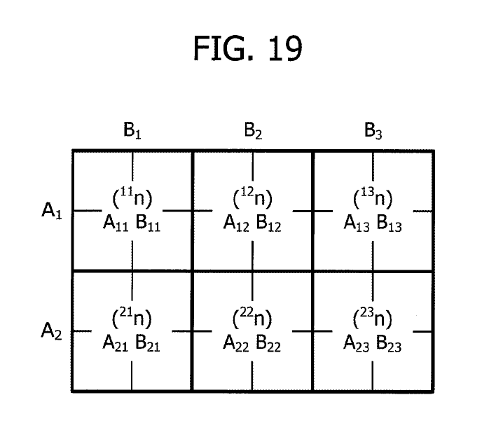

FIG. 19 is a first diagram illustrating an exemplary data arrangement according to the fourth embodiment. This example assumes that an exhaustive join is executed by six virtual nodes ¹¹n, ¹²n, ¹³n, ²¹n, ²²n, and ²³n (virtual nodes 20, 20a, 20b, 20c, 20d, and 20e in FIG. 15). Dataset A is formed from 24 data elements a₁ to a₂₄, while dataset B is formed from 48 data elements b₁ to b₄₈. According to the foregoing equation (10), the row dimension H is calculated to be 2, since the number of virtual nodes is six, and the number of data elements is 24 for dataset A and 48 for dataset B. In other words, the virtual node as a whole, is assigned two subsets Aᵢⱼ and Bᵢⱼ. For example, virtual node ¹¹n is assigned subset A₁₁ and subset B₁₁.

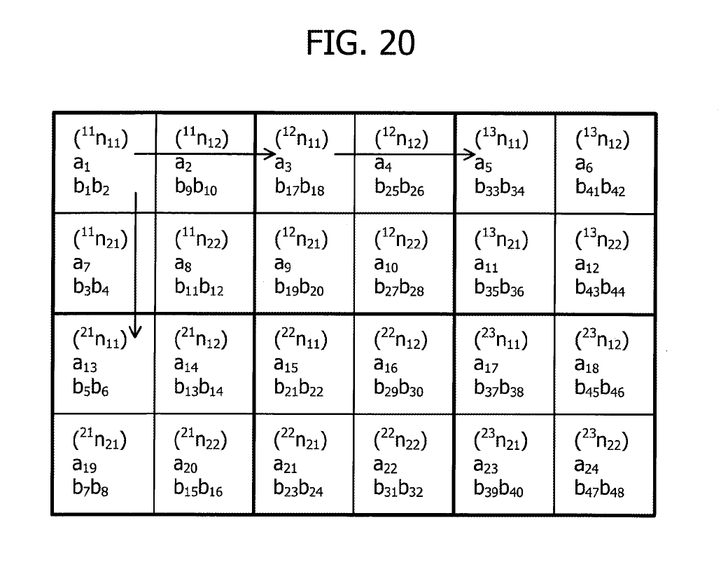

FIG. 20 is a second diagram illustrating an exemplary data arrangement according to the fourth embodiment. Virtual nodes ¹¹n, ¹²n, ¹³n, ²¹n, ²²n, and ²³n in the present example are each formed from four nodes n₁₁, n₁₂, n₂₁, and n₂₂. Each of those nodes has been equally assigned a subset of each source data set, including one data element from data set A and two data elements from dataset B. For example, node ¹¹n₁₁ has been assigned data elements a₁, b₁, and b₂.

The initial assignment of data elements has been made, and the row dimension H and column dimension W of virtual nodes are determined. Now the virtual nodes having the same row number duplicate their subsets of dataset A in the row direction, while the virtual nodes having the same column number duplicate their subsets of dataset B in the column direction. In this duplication, data elements are copied from one node in a virtual node to its counterpart in another virtual node. For example, data element a₁ initially assigned to node is copied from node ¹¹n₁₁ to node ¹²n₁₁, and then from node ¹²n₁₁ to node ¹³n₁₁. Further, data elements b₁ and b₂ initially assigned to node ¹¹n₁₁ is copied from node ¹¹n₁₁ to node ²¹n₁₁. No copying operations take place between non-associated nodes in this phase. For example, neither node ¹²n₁₂ nor node ¹³n₁₂ receives data element a₁ from node ¹¹n₁₁.

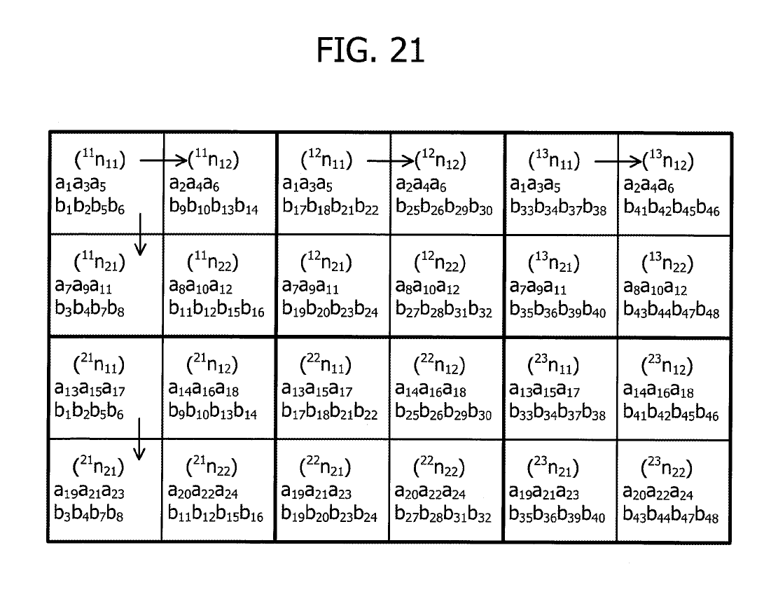

FIG. 21 is a third diagram illustrating an exemplary data arrangement according to the fourth embodiment. This example depicts the state after the above node-to-node data duplication is finished. That is, each node has obtained three data elements of dataset A and four data elements of dataset B. For example, node ¹¹n₁₁ now has data elements a₁, a₃, and a₅ of dataset A and data elements b₁, b₂, b₅, and b₆ of dataset B. According to the foregoing equation (10), the row dimension h is calculated to be 2 since the number of nodes per virtual node is 4, and the number of data elements per virtual node is 12 for dataset A and 16 for dataset B.

Now that the row dimension h and column dimension w of virtual nodes are determined, further duplication of data elements is performed within each virtual node. That is, the nodes having the same row number duplicate their respective subsets of dataset A in the row direction, including those received from other virtual nodes. Similarly the nodes having the same column number duplicate their subsets of dataset B in the column direction, including those received from other virtual nodes. For example, one set of data elements a₁, a₃, and a₅ collected in node ¹¹n₁₁ are copied from node ¹¹n₁₁ to node ¹¹n₁₂. Also, another set of data elements b₁, b₂, b₅, and b₆ collected in node ¹¹n₁₁ are copied node ¹¹n₁₁ to node ¹¹n₂₁. The nodes in a virtual node do not have to communicate with nodes in other virtual nodes during this phase of local duplication of data elements.

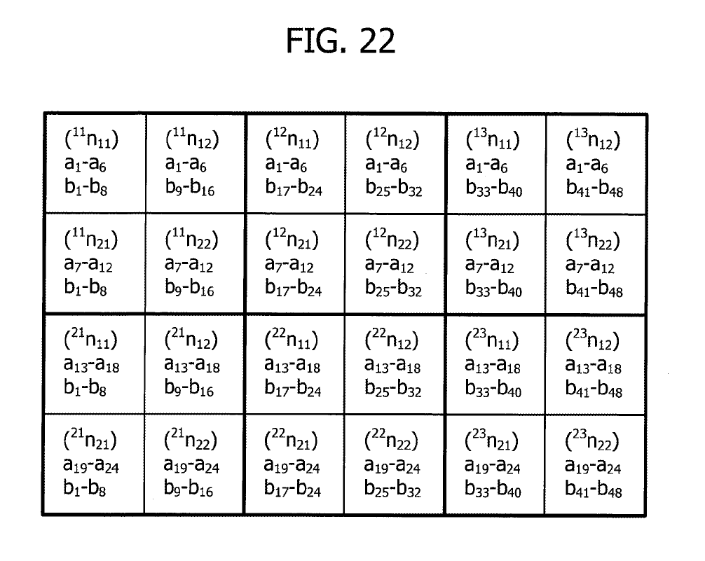

FIG. 22 is a fourth diagram illustrating an exemplary data arrangement according to the fourth embodiment. This example depicts the state after the above node-to-node data duplication is finished. Each node has obtained a row subset of dataset A and a column subset of dataset B. For example, the topmost six nodes ¹¹n₁₁, ¹¹n₁₂, ¹²n₁₁, ¹²n₁₂, ¹³n₁₁, ¹³n₁₂ have six data elements a₁ to a₆ as a row subset. The leftmost four nodes ¹¹n₁₁, ¹¹n₂₁, ²¹n₁₁, ²¹n₂₁ have eight data elements b₁ to b₈ as a column subset. The resultant distribution of data elements in those 24 nodes is identical to what would be obtained without virtualization of nodes.

Each node executes an exhaustive join with its local row subset and column subset obtained above. For example, node ¹¹n₁₁ selects one data element out of six data elements a₁ to a₆ and one element out of eight data elements b₁ to b₈ and subjects this combination of data elements to a map function. By repeating this operation, the node ¹¹n₁₁ applies the map function to 48 ordered pairs (i.e., 6×8 combinations) of data elements. All nodes equally executes their own 48 ordered pairs seen in FIG. 22. These twenty-six nodes as a whole cover all the 1152 (=24×48) ordered pairs produced from datasets A and B, without redundant duplication.

The proposed information processing system of the fourth embodiment provides advantages similar to those of the foregoing third embodiment. The fourth embodiment may further reduce unintended waiting times during inter-node communication by taking into consideration the unequal communication delays due to different physical distances between nodes. That is, the proposed system performs relatively slow communication between virtual nodes in the first place, and then proceeds to relatively fast communication within each virtual node. This feature of the fourth embodiment makes it easy to parallelize the communication, thus realizing a more efficient procedure for duplicating data elements.

### (e) Fifth Embodiment

This section describes a fifth embodiment with the focus on its differences from the third and fourth embodiments. See the previous description for their common elements and features. As will be described below, the fifth embodiment executes “triangle joins” instead of exhaustive joins. This fifth embodiment may be implemented in an information processing system with a structure similar to that of the third embodiment discussed previously in FIGS. 3, 4, and 10. Triangle joins may sometimes be treated as a kind of simple joins.

A triangle join is an operation on a single dataset A formed from m data elements a₁, a₂, . . . , aₘ (m is an integer greater than one). As seen in equation (11) below, this triangle join yields a new dataset by applying a map function to every unordered pair of two data elements aᵢ and aⱼ in dataset A with no particular relation between them. As in the case of exhaustive joins, the map function may return no output data elements or may output two or more resulting data elements, depending on the values of the arguments aᵢ and aⱼ. According to the definition of a triangle join seen in equation (11), the map function may be applied to a combination of the same data element (i.e., in the case of aᵢ=aⱼ). It is possible to define a map function that excludes such combinations.

t-join(A,map)={map(aᵢ,aⱼ)|aᵢ,aⱼεA,i≦j} (11)

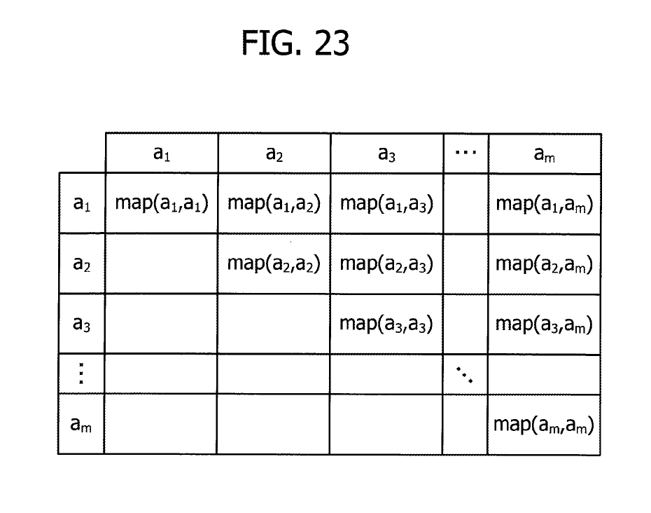

FIG. 23 illustrates a triangle join. Since triangle joins operate on unordered pairs of data elements, there is no need for calculating both map(aᵢ, aⱼ) and map(aⱼ, aᵢ). The map function is therefore applied to a limited number of combinations of data elements as seen in the form of a triangle when a two-dimensional matrix is produced from the data elements of dataset A. Specifically, the map function is executed on m(m+1)/2 combinations or m(m−1)/2 combinations of data elements. This means that the amount of data processing is nearly halved by using a triangle join in place of an exhaustive join of dataset A itself.

For example, a local triangle join on a single node may be implemented as a procedure described below. It is assumed that the node reads data elements on a block-by-block basis, where one block is made up of one or more data elements. It is also assumed that the node is capable of storing up to α blocks of data elements in its local RAM. When executing a triangle join of dataset A, the node loads the RAM with the topmost (α−1) blocks of data elements. For example, the node loads its RAM with two data elements a₁ and a₂. The node then executes a triangle join with these (α−1) blocks on RAM. For example, the node subjects three combinations (a₁, a₁), (a₁, a₂), and (a₂, a₂) to the map function.

Subsequently the node loads the next one block into RAM and executes an exhaustive join between the previous (α−1) blocks and the newly loaded block. For example, the node loads a data element a₃ into RAM and applies the map function to two new combinations (a₁, a₃) and (a₂, a₃). The node similarly processes the remaining blocks one by one until the last block is reached, while maintaining the topmost (α−1) blocks in its RAM. Upon completion of an exhaustive join between the topmost (α−1) blocks and the last one block, the node then flushes the existing (α−1) blocks in RAM and loads the next (α−1) blocks. For example, the node loads another two data elements a₃ and a₄ into RAM. With these new (α−1) blocks, the node executes a triangle join and exhaustive join in a similar way. The node iterates these operations until all possible (α−1) blocks are finished. It is noted that the final cycle of this iteration may not fully load (α−1) blocks, depending on the total number of blocks.

FIG. 23 depicts a plurality of such map operations. Since these operations are independent of each other, it is possible to parallelize their execution by assigning a plurality of nodes, just as in the case of exhaustive joins.

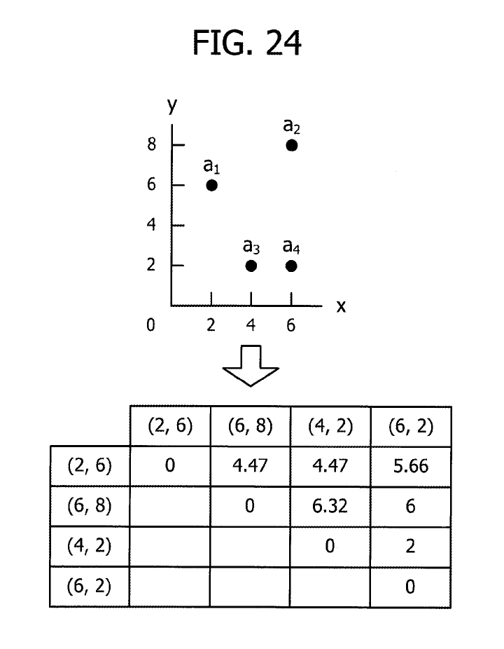

FIG. 24 illustrates an exemplary result of a triangle join. In this example of FIG. 24, dataset A is formed from four data elements a₁ to a₄, each including X-axis and Y-axis values representing a point on a plane. When two specific data elements are given as its arguments, the map function calculates the distance between the two corresponding points on the plane. A triangle join applies such a map function to 10 (=4×(4+1)/2) combinations of data elements. Alternatively, the combinations may be reduced to 6 (=4×(4−1)/2) in the case where the map function is not applied to combinations of the same data element (i.e., in the case of aᵢ=aⱼ).

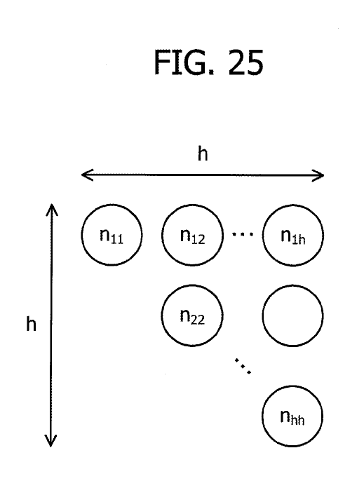

FIG. 25 illustrates a node coordination model according to the fifth embodiment. The triangle joins discussed in this fifth embodiment handle a plurality of participating nodes as if they are logically arranged in the form of an isosceles right triangle. The nodes are organized in a space with a height of h nodes (max) and a width of h nodes (max), such that (h−i+1) nodes are horizontally aligned in the i-th row, while j nodes are vertically aligned in the j-th column. The node sitting at the i-th row and j-th column is represented as nᵢⱼ in this model. The information processing system determines the row dimension h, depending on the number N of nodes used for its data processing. For example, the row dimension h may be selected as the maximum integer that satisfies h²<=N. In this case, a triangle join is executed by h² nodes.

The data elements of dataset A are initially distributed across h nodes n₁₁, n₂₂, . . . , nₕₕ on a diagonal line including the top-left node n₁₁ (i.e., the base of the isosceles right triangle). As in the case of exhaustive joins, these data elements are placed evenly (or near evenly) on these nodes without redundant duplication. At this stage, data elements are assigned to no other nodes, but the nodes on the diagonal line. For example, subset Aᵢ is assigned to node nᵢᵢ as seen in equation (12). Here the number of data elements of subset Aᵢ is determined by dividing the total number of elements in dataset A by the row dimension h.

$$A = {\sum }_{i = 1}^{h} {A}_{i} \\ \vert {A}_{i} \vert = \frac{\vert A \vert}{h} \qquad ( 12 )$$

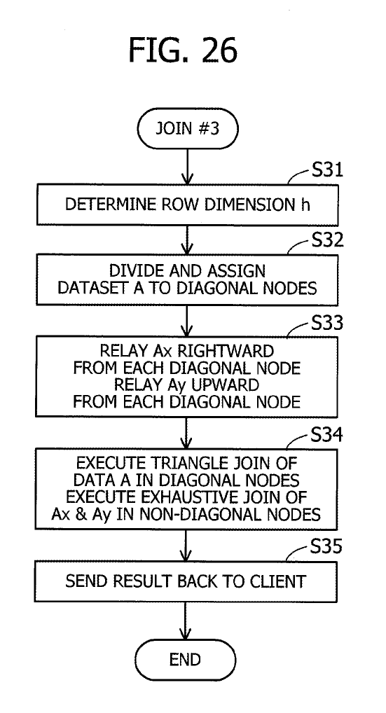

FIG. 26 is a flowchart illustrating an exemplary procedure of joins according to the fifth embodiment. Each step of the flowchart will be described below.

(S31) The system control unit 112 determines the row dimension h based on the number of participating nodes (i.e., those assigned to the triangle join), and defines logical connections of those nodes.

(S32) The client 31 has specified dataset A as input data for a triangle join. The system control unit 112 divides this dataset A into h subsets A₁, A₂, . . . , Aₕ and assigns them to h nodes including node n₁₁ on the diagonal line. These nodes may be referred to as “diagonal nodes” as used in FIG. 26. As an alternative, the node 11 may assign dataset A to these nodes according to a request from the client 31 before the node 11 receives a start command for data processing. As another alternative, dataset may be given as an output of previous data processing at these nodes. In this case, the system control unit 112 may find that dataset A has already been assigned to relevant nodes.

(S33) The system control unit 112 commands each diagonal node nᵢᵢ to duplicate its assigned subset Aᵢ in both the rightward and upward directions. The relaying of data subsets begins at each diagonal node nᵢᵢ, causing the execution unit in each relevant node to forward subset Aᵢ rightward and upward, but not downward or leftward. The above relaying may be achieved by using, for example, the method A discussed in FIG. 9A. The duplication of subset Aᵢ permits non-diagonal nodes nᵢⱼ to receive a copy of subset Aᵢ (Ax) initially assigned to node nᵢᵢ, as well as a copy of subset Aⱼ (Ay) initially assigned to node nⱼⱼ. The diagonal nodes nᵢᵢ, on the other hand, receive no extra data elements from other nodes.

(S34) The system control unit 112 commands the diagonal nodes to locally execute a triangle join. In response, the execution unit in each diagonal node nᵢᵢ executes a triangle join with its local subset Aᵢ and stores the result in a relevant data storage unit. The system control unit 112 also commands non-diagonal nodes to locally execute an exhaustive join. The non-diagonal nodes nᵢⱼ locally execute an exhaustive join of subset Ax and subset Ay respectively obtained in the above rightward relaying and upward relaying. The non-diagonal nodes nᵢⱼ store the result in relevant data storage units.

(S35) The system control unit 112 sees that every participating node has finished step S34, thus notifying the requesting client 31 of completion of the requested triangle join. The system control unit 112 may also collect result data from the data storage units of nodes and send it back to the client 31. Or alternatively, the system control unit 112 may allow the result data to stay in the nodes.

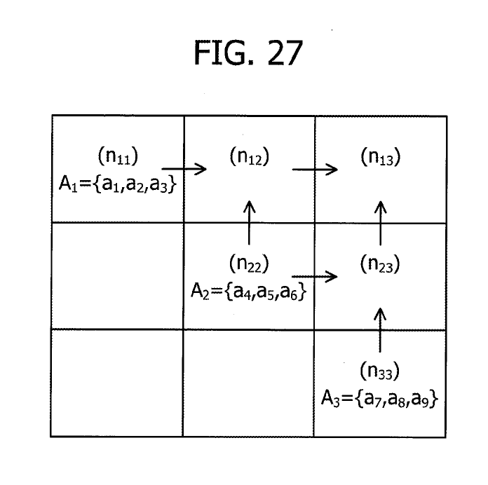

FIG. 27 is a first diagram illustrating an exemplary data arrangement according to the fifth embodiment. This example assumes that six nodes n₁₁, n₁₂, n₁₃, n₂₂, n₂₃, and n₃₃ are configured to execute a triangle join, where dataset A is formed from nine data elements a₁ to a₉. Each diagonal node nᵢᵢ is assigned a different subset Aᵢ including three data elements. For example, node n₁₁ is assigned a subset A₁={a₁, a₂, a₃}. Duplication of data elements then begins at each diagonal node nᵢᵢ, causing other nodes to forward subset Aᵢ in both the rightward and upward directions. For example, subset A₁ assigned to node n₁₁ is copied from node n₁₁ to node n₁₂, and then from node n₁₂ to node n₁₃. Similarly, subset A₂ assigned to node n₂₂ is copied upward from node n₂₂ to node n₁₂, as well as rightward from node n₂₂ to node n₂₃.

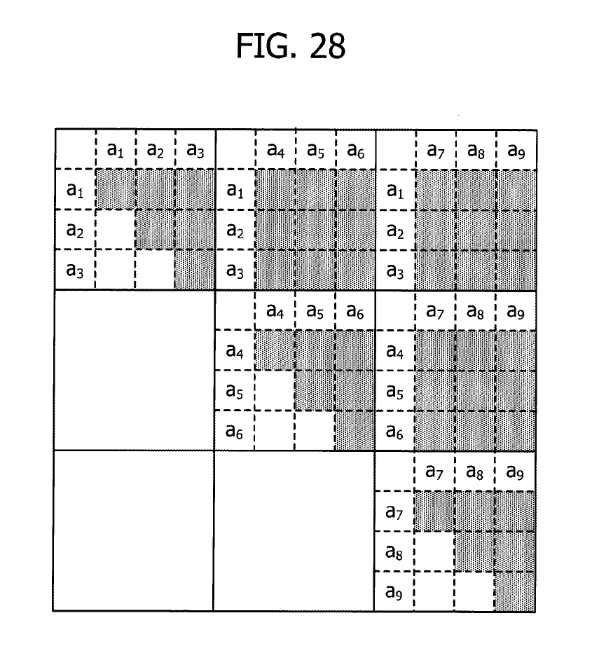

FIG. 28 is a second diagram illustrating an exemplary data arrangement according to the fifth embodiment. This example depicts the state after the above duplication of data elements is finished. That is, the diagonal nodes nᵢᵢ maintain their initially assigned subset Aᵢ alone. In contrast, the non-diagonal nodes nᵢⱼ have received subset Aᵢ from the nodes on their left and subset Aⱼ from the nodes below them. For example, node n₁₃ has obtained subset A₁={a₁, a₂, a₃} and subset A₃={a₇, a₈, a₉}.

The diagonal nodes nᵢᵢ locally execute a triangle join with their respective subset Aᵢ. For example, node n₁₁ applies the map function to six combinations derived from A₁={a₁, a₂, a₃}. On the other hand, the non-diagonal nodes nᵢⱼ locally execute an exhaustive join with their respective subsets Aᵢ and Aⱼ. For example, node n₁₃ applies the map function to nine (=3×3) ordered pairs derived from subsets A₁ and A₃, one element from subset A₁={a₁, a₂, a₃} and the other element from subset A₃={a₇, a₈, a₉}. As can be seen from FIG. 28, the illustrated nodes perfectly cover the 45 possible combinations of data elements of dataset A, without redundant duplication.

According to the fifth embodiment described above, the proposed information processing system executes triangle joins of dataset A in an efficient way, without needless duplication of data processing in the nodes.

### (f) Sixth Embodiment

This section describes a sixth embodiment with the focus on its differences from the foregoing third to fifth embodiments. See the previous description for their common elements and features. The sixth embodiment executes triangle joins in a different way from the one discussed in the fifth embodiment. This sixth embodiment may be implemented in an information processing system with a structure similar to that of the third embodiment discussed in FIGS. 3, 4, and 10.

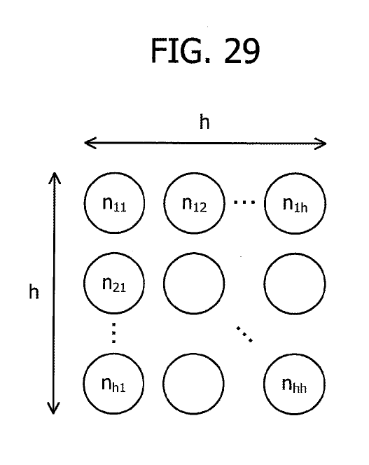

FIG. 29 illustrates a node coordination model according to the sixth embodiment. To execute a triangle join, this sixth embodiment handles a plurality of participating nodes as if they are logically arranged in the form of a square array. That is, the nodes are organized in an array with a height and width of h nodes. The information processing system determines this row dimension h, depending on the number of nodes used for its data processing. For example, the row dimension h may be selected as the maximum integer that satisfies h²<=N. In this case, a triangle join is executed by h² nodes. Data elements of dataset A are initially distributed over h nodes n₁₁, n₂₂, . . . , nₕₕ on a diagonal line including node n₁₁, similarly to the fifth embodiment.

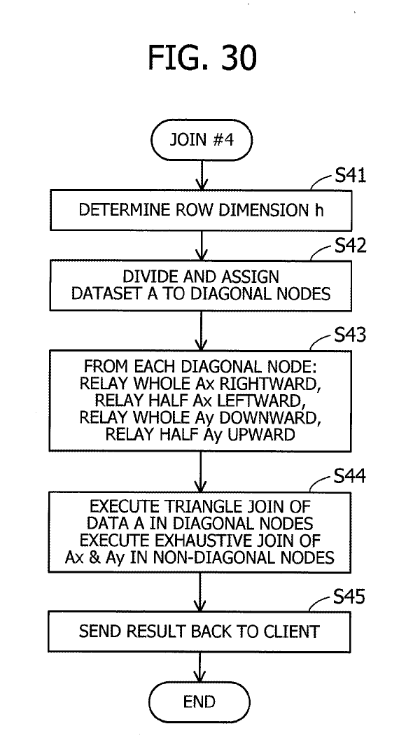

FIG. 30 is a flowchart illustrating an exemplary procedure of joins according to the sixth embodiment. Each step of the flowchart will be described below.

(S41) The system control unit 112 determines the row dimension h based on the number of participating nodes (i.e., nodes used to execute a triangle join), and defines logical connections of those nodes.

(S42) The client 31 has specified dataset A as input data for a triangle join. The system control unit 112 divides this dataset A into h subsets A₁, A₂, . . . , Aₕ and assigns them to h diagonal nodes including node n₁₁. As an alternative, the node 11 may assign dataset A to these nodes according to a request from the client 31 before the node 11 receives a start command for data processing. As another alternative, dataset may be given as an output of previous data processing at these nodes. In this case, the system control unit 112 may find that dataset A has already been assigned to relevant nodes.

(S43) The system control unit 112 commands each diagonal node nᵢᵢ to duplicate its assigned subset Aᵢ in both the row and column directions. The execution unit in each diagonal node nᵢᵢ transmits all data elements of subset Aᵢ in both the rightward and downward directions. The execution unit in each diagonal node nᵢᵢ further divides the subset Aᵢ into two halves as evenly as possible in terms of the number of data elements. The execution unit sends one half leftward and the other half upward. The above relaying may be achieved by using, for example, the method C discussed in FIG. 9C. As a result of this step, some non-diagonal nodes nᵢⱼ obtain a full copy of subset Aᵢ (Ax) initially assigned to node nᵢᵢ, as well as half a copy of subset Aⱼ (Ay) initially assigned to node nⱼⱼ. The other non-diagonal nodes nᵢⱼ obtain half a copy of subset Aᵢ (Ax), together with a full copy of subset Aⱼ (Ay). The diagonal nodes nᵢᵢ, on the other hand, receive no data elements from other nodes.

(S44) The system control unit 112 commands the diagonal nodes to locally execute a triangle join. In response, the execution unit in each diagonal node nᵢᵢ executes a triangle join of its local subset Aᵢ and stores the result in a relevant data storage unit. The system control unit 112 also commands non-diagonal nodes to locally execute an exhaustive join. The non-diagonal nodes nᵢⱼ locally execute an exhaustive join of subset Ax and subset Ay respectively obtained in the above row-wise relaying and column-wise relaying. The non-diagonal nodes nᵢⱼ store the result in relevant data storage units.

(S45) The system control unit 112 sees that every participating node has finished step S44, thus notifying the requesting client 31 of completion of the requested triangle join. The system control unit 112 may also collect result data from the data storage units of nodes and send it back to the client 31. Or alternatively, the system control unit 112 may allow the result data to stay in the nodes.

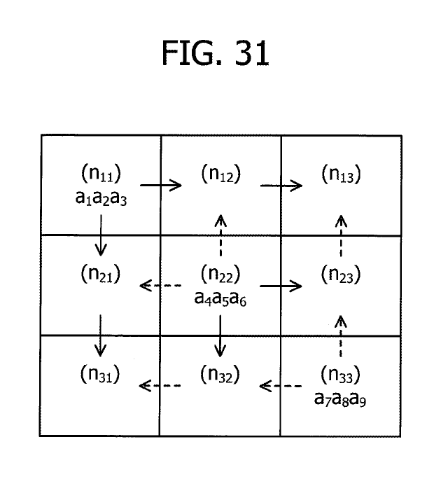

FIG. 31 is a first diagram illustrating an exemplary data arrangement according to the sixth embodiment. This example assumes that nine nodes n₁₁, n₁₂, . . . , n₃₃ are configured to execute a triangle join, where dataset A is formed from nine data elements a₁ to a₉. The diagonal nodes nᵢᵢ have each been assigned a subset Aᵢ including three data elements, as in the case of the fifth embodiment.

Duplication of data elements then begins at each diagonal node nᵢᵢ, causing other nodes to forward subset Aᵢ in both the rightward and downward directions. In addition to the above, the subset Aᵢ is divided into two halves, and one half is duplicated in the leftward direction while the other half is duplicated in the upward direction. For example, data elements a₄, a₅, and a₆ assigned to node n₂₂ are wholly copied from node n₂₂ to node n₂₃, as well as from node n₂₂ to node n₃₂. The data elements {a₄, a₅, a₆} are divided into two halves, {a₄} and {a₅, a₆}, where some error may be allowed in the number of elements. The former half is copied from node n₂₂ to node n₂₁, and the latter half is copied from node n₂₂ to node n₁₂.

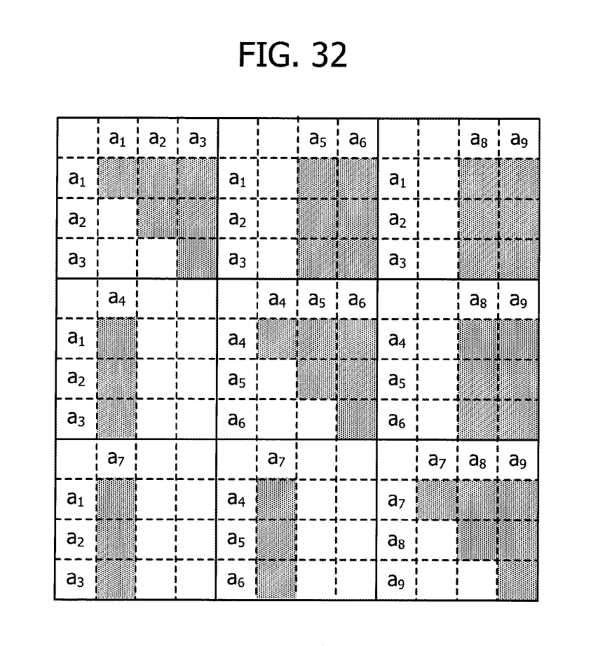

FIG. 32 is a second diagram illustrating an exemplary data arrangement according to the sixth embodiment. This example depicts the state after the above duplication of data elements is finished. That is, the diagonal nodes nᵢᵢ maintain their initially assigned subset Aᵢ alone. The non-diagonal nodes nᵢⱼ, on the other hand, have obtained a subset Ax (i.e., a full or half copy of subset Aᵢ) from their adjacent nodes on the same row. The non-diagonal nodes nᵢⱼ have also obtained a subset Ay (i.e., a full or half copy of subset Aⱼ) from their adjacent nodes on the same column. For example, node n₁₃ now has all data elements {a₁, a₂, a₃} of one subset A₁, together with two data elements a₈ and a₉ out of another subset A₃.

The diagonal nodes nᵢᵢ locally execute a triangle join of subset Aᵢ similarly to the fifth embodiment. The non-diagonal nodes execute an exhaustive join locally with the subset Ax and subset Ay that they have obtained. For example, node n₁₃ applies the map function to six (=3×2) ordered pairs, by combining one data element selected from {a₁, a₂, a₃} with another data element selected from {a₈, a₉}. As can be seen from FIG. 32, the method proposed in the sixth embodiment may be regarded as a modified version of the foregoing fifth embodiment. That is, one half of the data processing tasks in non-diagonal nodes is delegated to the nodes located below the diagonal line. The nine nodes completely cover the 45 combinations of data elements of dataset A, without redundant duplication.

The proposed information processing system of the sixth embodiment executes a triangle join of dataset A efficiently by using a plurality of nodes. Particularly, the sixth embodiment is advantageous in its ability of distributing the load of data processing to the nodes as evenly as possible.

### (g) Seventh Embodiment

This section describes a seventh embodiment with the focus on its differences from the foregoing third to sixth embodiments. See the previous description for their common elements and features. The seventh embodiment executes triangle joins in a different way from those discussed in the fifth and sixth embodiments. This seventh embodiment may be implemented in an information processing system with a structure similar to that of the third embodiment discussed in FIGS. 3, 4, and 10.

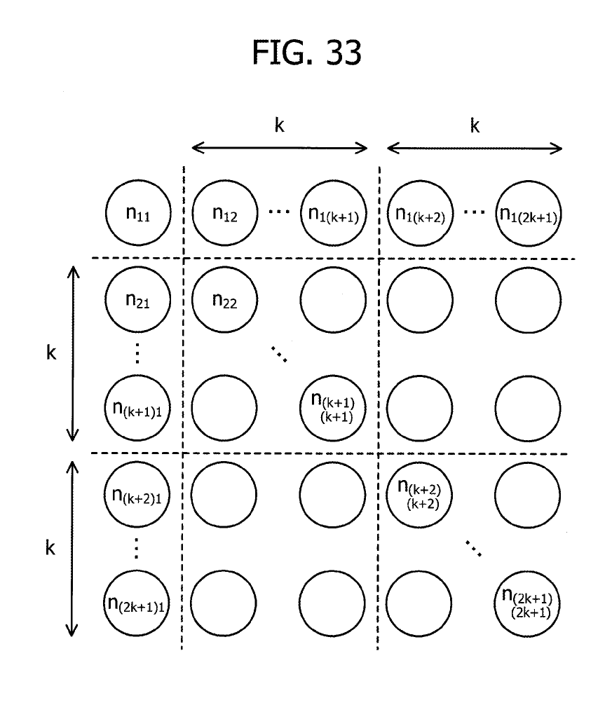

FIG. 33 illustrates a node coordination model according to the seventh embodiment. To execute a triangle join, this seventh embodiment handles a plurality of participating nodes as if they are logically arranged in the form of a square array. Specifically, the array of nodes has a height and width of 2k+1, where k is an integer greater than zero. In other words, each side of the square has an odd number of nodes which is greater than or equal to three. The information processing system determines a row dimension h=2k+1, depending on the number of nodes available for its data processing. For example, the row dimension h may be selected as the maximum odd number that satisfies h²<=N. In this case, a triangle join is executed by h² nodes. The triangle joins discussed in this seventh embodiment assume that these nodes are connected logically in a torus topology. For example, node nᵢ₁ is located at the right of node nᵢₕ. Node n₁ⱼ is located below node nₕⱼ. Data elements of dataset A are initially distributed over h nodes n₁₁, n₂₂, . . . , nₕₕ on a diagonal line including node n₁₁.

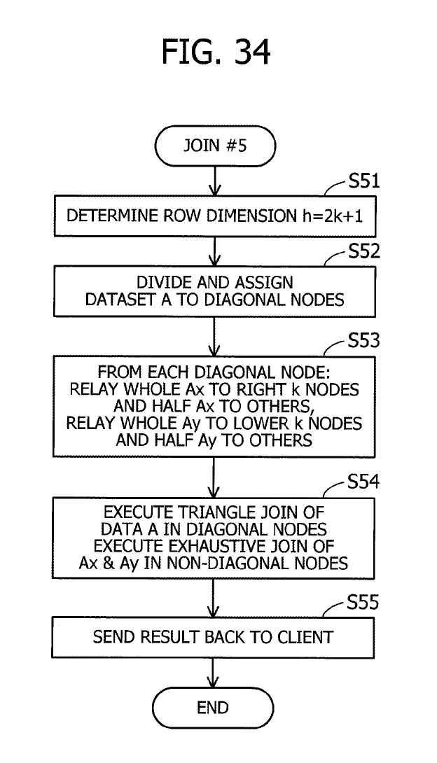

FIG. 34 is a flowchart illustrating an exemplary procedure of joins according to the seventh embodiment. Each step of the flowchart will be described below.

(S51) The system control unit 112 determines the row dimension h=2k+1 based on the number of participating nodes (i.e., nodes used to execute a triangle join), and defines logical connections of those nodes.

(S52) The client 31 has specified dataset A as input data for a triangle join. The system control unit 112 divides this dataset A into h subsets A₁, A₂, . . . , Aₕ and assigns them to h diagonal nodes including node n₁₁. As an alternative, the node 11 may assign dataset A to these nodes according to a request from the client 31 before the node 11 receives a start command for data processing. As another alternative, dataset may be given as an output of previous data processing at these nodes. In this case, the system control unit 112 may find that dataset A has already been assigned to relevant nodes.

(S53) The system control unit 112 commands each diagonal node nᵢᵢ to duplicate its assigned subset Aᵢ in both the row and column directions. In response, the execution unit in each diagonal node nᵢᵢ transmits a copy of subset Aᵢ to the node on the right of node nᵢᵢ, as well as to the node immediately below node nᵢᵢ.

Subsets are thus relayed in the row direction. During this course, the execution units in the first to k-th nodes located on the right of node nᵢᵢ receive subset Aᵢ from their left neighbors. The execution units in the (k+1)th to (2k)th nodes receive one half of subset Aᵢ from their left neighbors. These subsets are referred to collectively as Ax. Subsets are also relayed in the column direction. During this course, the execution units in the first to k-th nodes below node nᵢᵢ receive subset Aᵢ from their upper neighbors. The execution units in the (k+1)th to (2k)th nodes receive the other half of subset Aᵢ from their upper neighbors. These subsets are referred to collectively as Ay. The above relaying may be achieved by using, for example, the method B discussed in FIG. 9B.

As a result of step S53, some non-diagonal nodes nᵢⱼ obtain a full copy of subset Aᵢ (Ax) initially assigned to node nᵢᵢ, as well as half a copy of subset Aⱼ (Ay) initially assigned to node nⱼⱼ. The other non-diagonal nodes nᵢⱼ obtain half a copy of subset Aᵢ (Ax), together with a full copy of subset Aⱼ (Ay). The diagonal nodes nᵢᵢ, on the other hand, receive no data elements from other nodes.

(S54) The system control unit 112 commands the diagonal nodes to locally execute a triangle join. In response, the execution unit in each diagonal node nᵢᵢ executes a triangle join of its local subset Aᵢ and stores the result in a relevant data storage unit. The system control unit 112 also commands non-diagonal nodes to locally execute an exhaustive join. The non-diagonal nodes nᵢⱼ locally execute an exhaustive join of subset Ax and subset Ay respectively obtained in the above row-direction relaying and column-direction relaying. The non-diagonal nodes nᵢⱼ store the result in relevant data storage units.

(S55) The system control unit 112 sees that every participating node has finished step S54, thus notifying the requesting client 31 of completion of the requested triangle join. The system control unit 112 may further collect result data from the data storage units of nodes and send it back to the client 31. Or alternatively, the system control unit 112 may allow the result data to stay in the nodes.

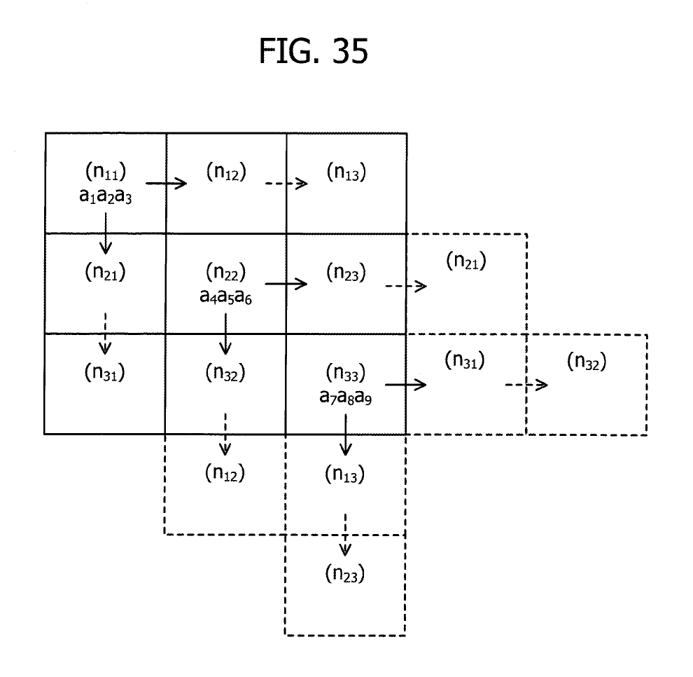

FIG. 35 is a first diagram illustrating an exemplary data arrangement according to the seventh embodiment. The illustrated arrangement is a case of k=1, where nine (3×3) nodes n₁₁, n₁₂, . . . , n₃₃ are configured to execute a triangle join. Dataset A is formed from nine data elements a₁ to a₉. Each diagonal node is assigned a different subset including three data elements.

For example, data elements a₁, a₂, and a₃ assigned to one diagonal node n₁₁ are wholly copied to node n₁₂, and one half of them (e.g., data element a₃) are copied to node n₁₃. The same data elements a₁, a₂, and a₃ are wholly copied to node n₂₁, and the other half of them (e.g., data elements a₁ and a₂) are copied to node n₃₁. Similarly, data elements a₄, a₅, and a₆ assigned to another diagonal node n₂₂ are wholly copied to node n₂₃, and one half of them (e.g., data element a₄) are copied to node n₂₁. The same data elements a₄, a₅, and a₆ are wholly copied to node n₃₂, and the other half of them (e.g., data elements a₅ and a₆) are copied to node n₁₂. Further, data elements a₇, a₈, and a₉ assigned to yet another diagonal node n₃₃ are wholly copied to node n₃₁, and one half of them (e.g., data element a₇) are copied to node n₃₂. The same data elements a₇, a₈, and a₉ are wholly copied to node n₁₃, and one half of them (e.g., data elements a₈ and a₉) are copied to node n₂₃.

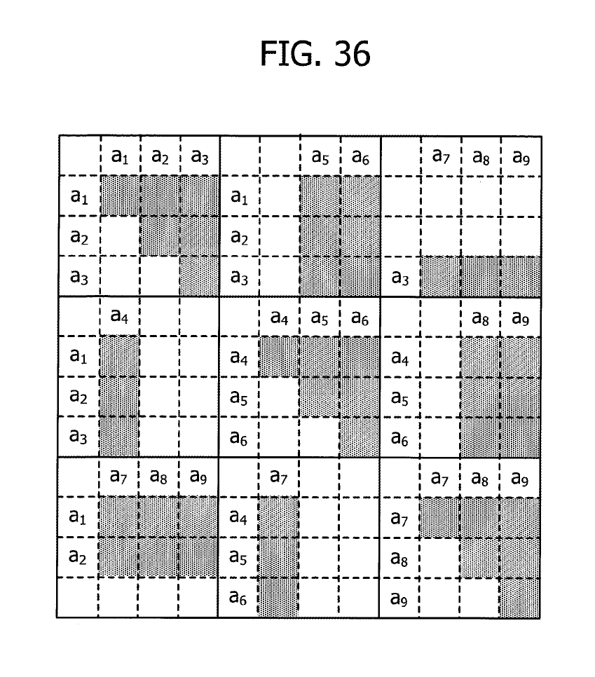

FIG. 36 is a second diagram illustrating an exemplary data arrangement according to the seventh embodiment. This example depicts the state after the above duplication of data elements is finished. That is, the diagonal nodes nᵢᵢ maintain their initially assigned subset Aᵢ alone. The non-diagonal nodes nᵢⱼ, on the other hand, have obtained a subset Ax (i.e., a full or half copy of subset Aᵢ) from their left neighbors. The non-diagonal nodes nᵢⱼ have also obtained a subset Ay (i.e., a full or half copy of subset Aⱼ) from their upper neighbors. The diagonal nodes nᵢᵢ locally execute a triangle join of subset Aᵢ similarly to the fifth and sixth embodiments. The non-diagonal nodes locally execute an exhaustive join of the subset Ax and subset Ay that they have obtained.

The proposed information processing system of the seventh embodiment provides advantages similar to those of the foregoing sixth embodiment. Another advantage of the seventh embodiment is that the amount of transmit data of diagonal nodes are equalized or nearly equalized. For example, the nodes n₁₁, n₂₂, and n₃₃ in FIG. 35 transmit the same amount of data. This feature of the seventh embodiment makes it more efficient to duplicate data elements from node to node.

### (h) Eighth Embodiment

This section describes an eighth embodiment with the focus on its differences from the foregoing third to seventh embodiments. See the previous description for their common elements and features. The eighth embodiment executes triangle joins in a different way from those discussed in the fifth to seventh embodiments. This eighth embodiment may be implemented in an information processing system with a structure similar to that of the third embodiment discussed in FIGS. 3, 4, and 10.

The eighth embodiment handles a plurality of participating nodes of a triangle join as if they are logically arranged in the same form discussed in FIG. 33 for the seventh embodiment. The difference lies in its initial distribution of data elements. That is, the eighth embodiment first distributes a given dataset A evenly (or near evenly) among the participating nodes, without redundant duplication. For example, subset Aᵢⱼ is assigned to node nᵢⱼ in the way described in equation (13). The number of data elements per subset is determined by dividing the total number of elements of dataset A by the number N of nodes, where N=h²=(2k+1)².

$$A = {\sum }_{i = 1}^{h} {\sum }_{j = 1}^{h} {A}_{ij} \\ \vert {A}_{ij} \vert = \frac{\vert A \vert}{{h}^{2}} \qquad ( 13 )$$

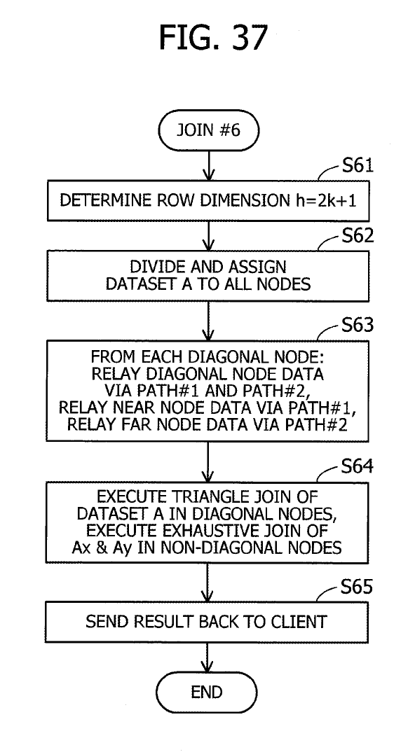

FIG. 37 is a flowchart illustrating an exemplary procedure of joins according to the eighth embodiment. Each step of the flowchart will be described below.

(S61) The system control unit 112 determines the row dimension h=2k+1 based on the number of participating nodes, and defines logical connections of those nodes.

(S62) The client 31 has specified dataset A as input data. The system control unit 112 divides that dataset A into N subsets and assigns them to a plurality of nodes, where N=(2k+1)². As an alternative, the node 11 may assign dataset A to these nodes according to a request from the client 31 before the node 11 receives a start command for data processing. As another alternative, dataset may be given as an output of previous data processing at these nodes. In this case, the system control unit 112 may find that dataset A has already been assigned to relevant nodes.

(S63) The system control unit 112 commands the nodes to initiate “near-node relaying” and “far-node relaying” with respect to the locations of diagonal nodes. The execution unit in each node relays subsets of dataset A via two paths. Non-diagonal nodes are classified into near nodes and far nodes, depending on their relative locations to a relevant diagonal node nᵢᵢ. More specifically, the term “near nodes” refers to node nᵢ₍ᵢ₊₁₎ to node nᵢ₍ᵢ₊ₖ₎, i.e., the first to k-th nodes sitting on the right of diagonal node nᵢᵢ. The term “far nodes” refers to node nᵢ₍ᵢ₊ₖ₊₁₎ to node nᵢ₍ᵢ₊₂ₖ₎, i.e., the (k+1)th to (2k)th nodes on the right of diagonal node nᵢᵢ. As mentioned above, the participating nodes are logically arranged in a square array and connected with each other in a torus topology.

Near-node relaying delivers data elements along a right-angled path (path #1) that runs from node n₍ᵢ₊₂ₖ₎ᵢ up to node nᵢᵢ and then turns right to node nᵢ₍ᵢ₊ₖ₎. Far-node relaying delivers data elements along another right-angled path (path #2) that runs from node n₍ᵢ₊ₖ₎ᵢ up to node nᵢᵢ and turns right to node nᵢ₍ᵢ₊₂ₖ₎. Subsets Aᵢᵢ assigned to the diagonal nodes nᵢᵢ are each divided evenly (or near evenly) into two halves, such that their difference in the number of data elements does not exceed one. One half is then duplicated to the nodes on path #1 by the near-node relaying, while the other half is duplicated to the nodes on path #2 by the far-node relaying. The near-node relaying also duplicates subsets Aᵢ₍₊₁₎ to Aᵢ₍ᵢ₊ₖ₎ of near nodes to other nodes on path #1. The far-node relaying also duplicates subsets Aᵢ₍ᵢ₊ₖ₊₁₎ to Aᵢ₍ᵢ₊₂ₖ₎ of far nodes to other nodes on path #2.

The above-described relaying of data subsets from a diagonal node, near node, and far node is executed as many times as the number of diagonal nodes, i.e., h=2k+1. These duplicating operations permit each node to collect as many data elements as those obtained in the seventh embodiment.

The above duplication method of the eighth embodiment may be worded in a different way as follows. The proposed method first distributes initial subsets of dataset A evenly to the participating nodes. Then the diagonal node on each row collects data elements from other nodes, and redistributes the collected data elements so that the duplication process yields a final result similar to that of the seventh embodiment.

(S64) The system control unit 112 commands the diagonal nodes to locally execute a triangle join. In response, the execution unit in each diagonal node nᵢᵢ locally executes a triangle join of the subsets collected through the above relaying and stores the result in a relevant data storage unit. The system control unit 112 also commands non-diagonal nodes to locally execute an exhaustive join. The non-diagonal nodes nᵢⱼ locally execute an exhaustive join between the subsets Ax collected through the above relaying performed with reference to a diagonal node nᵢᵢ and the subsets Ay collected through the above relaying performed with reference to another diagonal node nⱼⱼ. The non-diagonal nodes nᵢⱼ store the result in relevant data storage units.

(S65) The system control unit 112 sees that every participating node has finished step S64, thus notifying the requesting client 31 of completion of the requested triangle join. The system control unit 112 may further collect result data from the data storage units of nodes and send it back to the client 31. Or alternatively, the system control unit 112 may allow the result data to stay in the nodes.

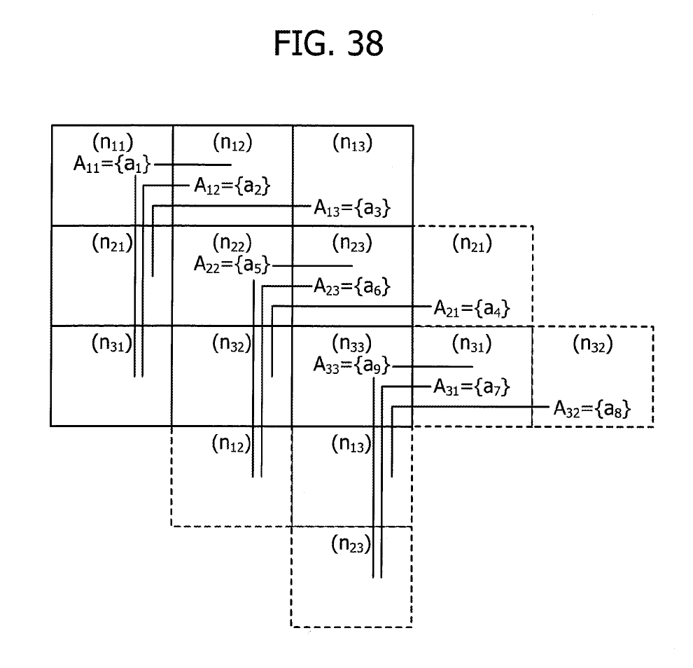

FIG. 38 is a first diagram illustrating an exemplary data arrangement according to the eighth embodiment. Seen in FIG. 38 is the case of k=1, where nine (3×3) nodes n₁₁, n₁₂, . . . , n₃₃ are configured to execute a triangle join. Dataset A is formed from nine data elements a₁ to a₉, and the nodes nᵢⱼ are initially assigned different subsets Aᵢⱼ each including a single data element.

Subset A₁₁ of node n₁₁ is duplicated to other nodes n₁₂, n₂₁, and n₃₁ through near-node relaying. Subset A₁₁ is not subjected to far-node relaying in this example because subset A₁₁ contains only one data element. Subset A₁₂ of node n₁₂ is duplicated to other nodes n₁₁, n₂₁, and n₃₁ through near-node relaying. Subset A₂₃ of node n₁₃ is duplicated to other nodes n₁₁, n₁₂, and n₂₁ through far-node relaying.

Subset A₂₂ of node n₂₂ is duplicated to other nodes n₂₃, n₃₂, and n₁₂ through near-node relaying. The subset A₂₂ is not subjected to far-node relaying in this example because it contains only one data element. Subset A₂₃ of node n₂₃ is duplicated to other nodes n₂₂, n₃₂, and n₁₂ through near-node relaying. Subset A₂₁ of node n₂₁ is duplicated to other nodes n₂₂, n₂₃, and n₃₂ through far-node relaying.

Subset A₃₃ of node n₃₃ is duplicated to other nodes n₃₁, n₂₃, and n₂₃ through near-node relaying. The subset A₃₃ is not subjected to far-node relaying in this example because it contains only one data element. Subset A₃₁ of node n₃₁ is duplicated to other nodes n₃₃, n₁₃, n₂₃ through near-node relaying. Subset A₃₂ of node n₃₂ is duplicated to other nodes n₃₃, n₃₁, and n₁₃ through far-node relaying.

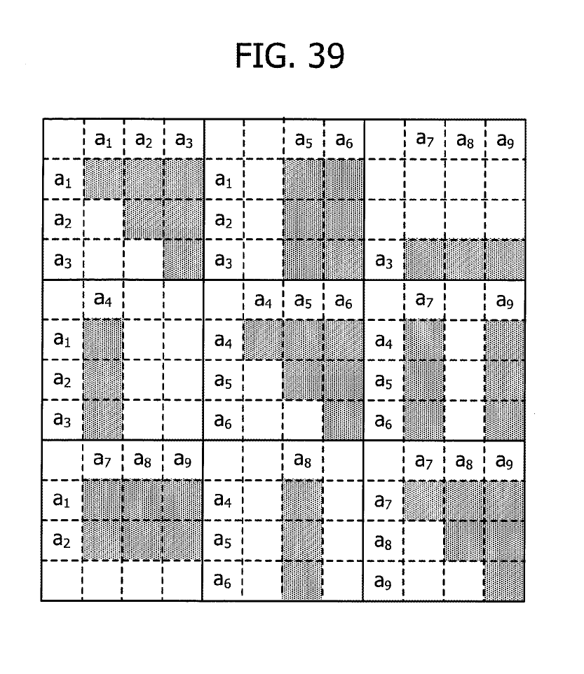

FIG. 39 is a second diagram illustrating an exemplary data arrangement according to the eighth embodiment. This example depicts the state after the above duplication of data elements is finished. That is, the diagonal nodes nᵢᵢ have collected data elements initially assigned to the nodes nᵢ₁ to nᵢₕ on the i-th row. The non-diagonal nodes nᵢⱼ, on the other hand, have obtained a subset Ax collected through the above relaying performed with reference to a diagonal node nᵢᵢ, as well as a subset Ay collected through the above relaying performed with reference to another diagonal node nⱼⱼ. The diagonal nodes nᵢᵢ locally execute a triangle join of the collected subset in a similar way to the foregoing fifth to seventh embodiments. The non-diagonal nodes locally execute an exhaustive join of the two subsets Ax and Ay obtained above.

The proposed information processing system of the eighth embodiment provides advantages similar to those of the foregoing seventh embodiment. The eighth embodiment is configured to assign data elements, not only to diagonal nodes, but also to non-diagonal nodes, as evenly as possible. This feature of the eighth embodiment reduces the chance for non-diagonal nodes to enter a wait state in the initial stage of data duplication, thus enabling more efficient duplication of data elements among the nodes.

### (h) Ninth Embodiment

This section describes a ninth embodiment with the focus on its differences from the foregoing third to eighth embodiments. See the previous description for their common elements and features. To execute triangle joins, the ninth embodiment uses a large-scale information processing system formed from a plurality of communication devices interconnected in a hierarchical way. This information processing system of the ninth embodiment may be implemented on a hardware platform of FIG. 4, configured with a system structure similar to that of the fourth embodiment discussed previously in FIGS. 15 and 17.

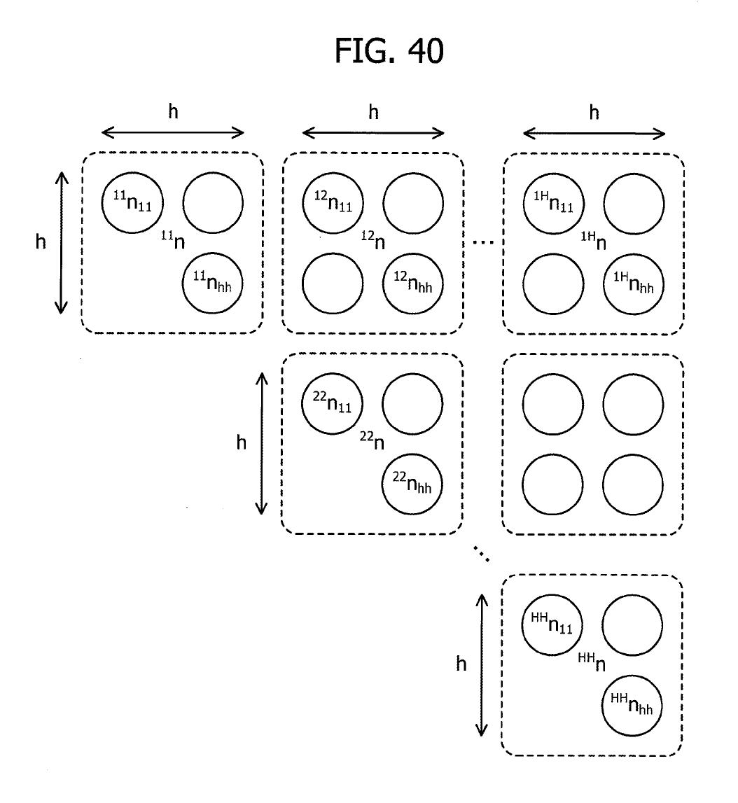

FIG. 40 illustrates a node coordination model according to the ninth embodiment. When executing triangle joins, the ninth embodiment handles a plurality of virtual nodes as if they are logically arranged in the form of a right triangle. That is, the virtual nodes are organized in a space with a height of H (max) and a width of H (max), such that (H−i+1) virtual nodes are horizontally aligned in the i-th row while j virtual nodes are vertically aligned in the j-th column. The information processing system determines the row dimension H, depending on the number N of virtual nodes used for its data processing. For example, the row dimension H may be selected as the maximum integer that satisfies H²<=N. In this case, a triangle join is executed by H² virtual nodes. The total number of virtual nodes contained in the system and the total number of nodes per virtual node are determined taking into consideration the number of participating nodes, connection with network devices, the amount of data to be processed, expected response time of the system, and other parameters.

In the virtual nodes sitting on the illustrated diagonal line (referred to as “diagonal virtual nodes”), their constituent nodes are handled as if they are logically arranged in the form of a right triangle. That is, the nodes in such a virtual node are organized in a space with a height of h (max) and a width of h (max), such that (h−i+1) nodes are horizontally aligned in the i-th row while j nodes are vertically aligned in the j-th column. In non-diagonal virtual nodes, on the other hand, their constituent nodes are handled as if they are logically arranged in the form of a square array. That is, the nodes in such a virtual node are organized as an array of h×h nodes. This row dimension h is common to all virtual nodes. For example, the row dimension h may be selected as the maximum integer that satisfies h²<=M, where M is the number of nodes constituting a virtual node. In this case, each virtual node contains h² nodes.

At the start of a triangle join, the system divides and assigns dataset A to all nodes n₁₁, . . . , nₕₕ included in all participating virtual nodes ¹¹n, . . . , ^{HW}n. That is, the data elements are distributed evenly (or near evenly) to those nodes without needless duplication. Similarly to the foregoing fourth embodiment, the initially assigned data elements are then duplicated from virtual node to virtual node via two or more different intervening switches. Subsequently the data elements are duplicated within each closed domain of the virtual node. Communication between two virtual nodes is implemented as communication between “associated nodes” in them. While FIG. 40 illustrates an example of virtualization into a single layer, it is also possible to build a multiple-layer structure of virtual nodes such that one virtual node includes other virtual nodes.

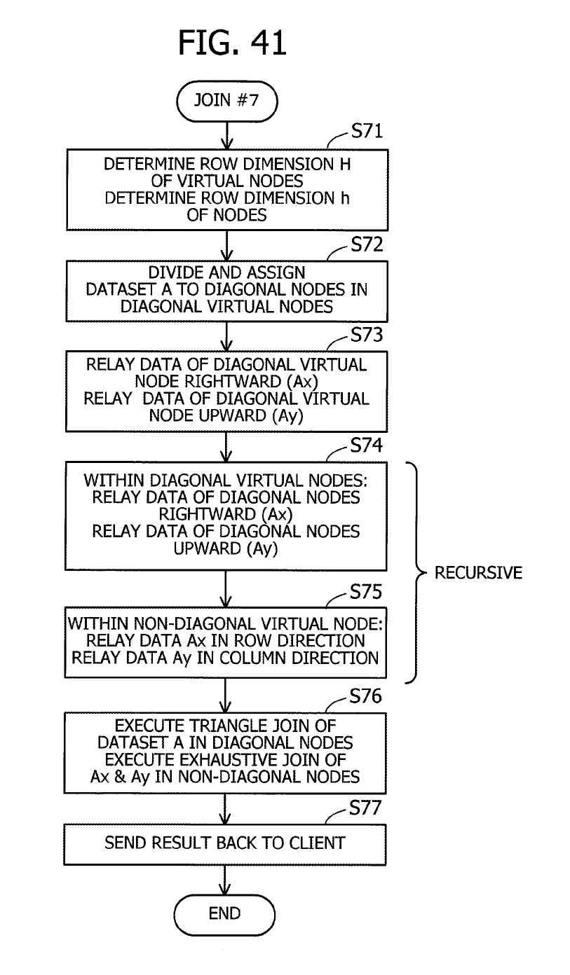

FIG. 41 is a flowchart illustrating an exemplary procedure of joins according to the ninth embodiment. Each step of the flowchart will be described below.

(S71) Based on the number of virtual nodes available for computation of triangle joins, the system control unit 212 determines the row dimension H of virtual nodes and defines their logical connections. The system control unit 212 also determines the row dimension h of nodes as a common parameter of virtual nodes.

(S72) Input dataset A has been specified by the client 31. The system control unit 212 divides this dataset A into as many subsets as the number of diagonal virtual nodes, and assigns the resulting subsets to those virtual nodes. In each virtual node, the virtual node control unit subdivides the assigned subset into as many smaller subsets as the number of diagonal nodes in that virtual node and assigns the divided subsets to those nodes. The input dataset A is distributed to a plurality of nodes as a result of the above operation. As an alternative, the assignment of dataset A may be performed upon a request from the client 31 before the node 21 receives a start command for data processing. As another alternative, the dataset A may be given as an output of previous data processing at these nodes. In this case, the system control unit 212 may find that dataset A has already been assigned to relevant nodes.

(S73) The system control unit 212 commands the deputy node of each diagonal virtual node ¹¹n, ²²n, . . . , ^{HH}n to duplicate data elements to other virtual nodes. In response, the virtual node control unit of each deputy node commands diagonal nodes n₁₁, n₂₂, . . . , nₕₕ to duplicate data elements to other virtual nodes in the rightward and upward directions. The execution unit in each diagonal node sends a copy of data elements to its corresponding node in the right virtual node. These data elements are referred to as a subset Ax. The execution unit also sends a copy of data elements to its corresponding node in the upper virtual node. These data elements are referred to as a subset Ay.

(S74) The system control unit 212 commands the deputy node of each diagonal virtual node ¹¹n, ²²n, . . . , ^{HH}n to duplicate data elements within the individual virtual nodes. In response, the virtual node control unit of each deputy node commands diagonal nodes n₁₁, n₂₂, . . . , nₕₕ to duplicate their data elements to other nodes in the rightward and upward directions. The relaying of data subsets Ax and Ay begins at each diagonal node, causing the execution unit in each relevant node to forward data elements in the rightward and upward directions.

(S75) The system control unit 212 commands the deputy node of each non-diagonal virtual node to duplicate data elements within the individual virtual nodes. In response, the virtual node control unit in each deputy node commands the diagonal nodes n₁₁, n₂₂, . . . , nₕₕ to send a copy of subset Ax in the row direction, where subset Ax has been received from the left virtual node. Similarly the virtual node control unit commands the diagonal nodes n₁₁, n₂₂, . . . , nₕₕ to send a copy of subset Ay in the column direction, where subset Ay has been received from the lower virtual node. The execution unit in each node relays subsets Ax and Ay in their specified directions. Steps S74 and S75 may be executed recursively in the case where the virtual nodes are nested in a multiple-layer structure. This recursive operation may be implemented by causing the virtual node control unit to inherit the above-described role of the system control unit 212. The same may apply to step S72.

(S76) The system control unit 212 commands the deputy node of each diagonal virtual node ¹¹n, ²²n, . . . , ^{HH}n to execute a triangle join. In response, the virtual node control unit in each deputy node commands the diagonal nodes n₁₁, n₂₂, . . . , nₕₕ to execute a triangle join, while instructing the non-diagonal nodes to execute an exhaustive join. The execution unit in each diagonal node locally executes a triangle join of its own subset and stores the result in a relevant data storage unit. The execution unit of each non-diagonal node locally executes an exhaustive join between subsets Ax and Ay and stores the result in a relevant data storage unit.

The system control unit 212 also commands the deputy node of each non-diagonal virtual node to execute an exhaustive join. In response, the virtual node control unit of each deputy node commands each node in the relevant virtual node to execute an exhaustive join. The execution unit of each node locally executes an exhaustive join between subsets Ax and Ay and stores the result in a relevant data storage unit.

(S77) The system control unit 212 sees that every participating node has finished step S76, thus notifying the requesting client 31 of completion of the requested triangle join. The system control unit 212 may further collect result data from the data storage units of nodes and send it back to the client 31. Or alternatively, the system control unit 212 may allow the result data to stay in the nodes.

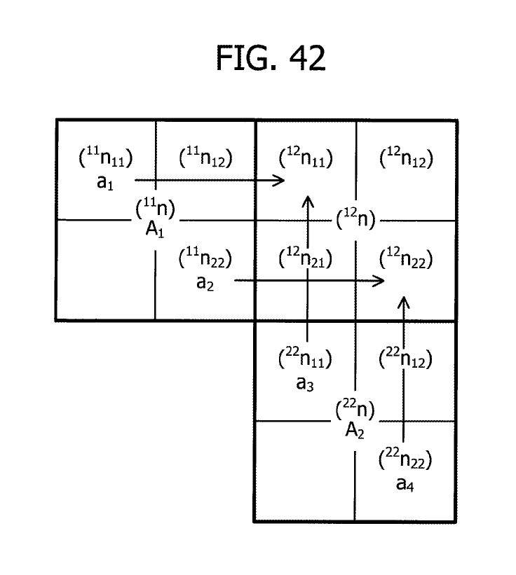

FIG. 42 a first diagram illustrating an exemplary data arrangement according to the ninth embodiment. This example includes three virtual nodes 11n, 12n, and 22n configured to execute a triangle join. The diagonal virtual nodes ¹¹n and ²²n each contain three nodes n₁₁, n₁₂, and n₂₂, whereas the non-diagonal virtual node ¹²n contain four nodes n₁₁, n₁₂, n₂₁, and n₂₂. It is assumed that dataset A is formed from four data elements a₁ to a₄. Referring now to the two diagonal virtual nodes, their diagonal nodes ¹¹n₁₁, ¹¹n₂₂, ²²n₁₁, and ²²n₂₂ are each assigned one data element. In other words, one virtual node ¹¹n, as a whole, is assigned a subset A₁={a₁, a₂}, and another virtual node ¹²n is assigned another subset A₂={a₃, a₄}.

The assigned data elements are duplicated from virtual node to virtual node. More specifically, data element a₁ of node ¹¹n₁₁ is copied to its counterpart node ¹²n₁₁, and data element a₂ of node ¹¹n₂₂ is copied to its counterpart node ¹²n₂₂. Further, data element a₃ of node ²²n₁₁ is copied to its counterpart node ¹²n₁₁, and data element a₄ of node ²²n₂₂ is copied to its counterpart node ¹²n₂₂. No copy is made to non-associated nodes in this phase.

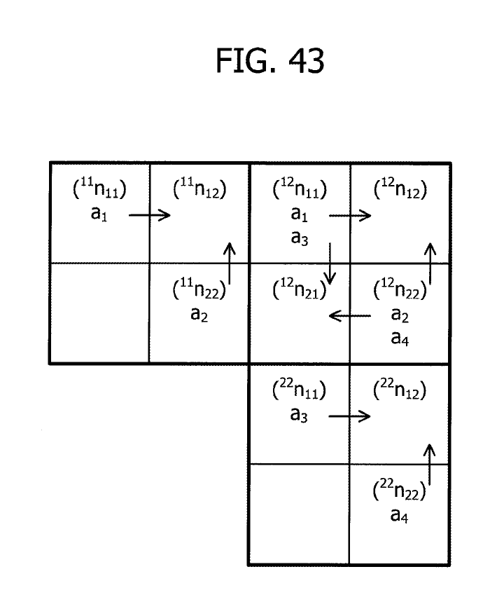

FIG. 43 is a second diagram illustrating an exemplary data arrangement according to the ninth embodiment. This example depicts the state after the above node-to-node data duplication is finished. That is, the two diagonal nodes ¹²n₁₁ and ¹²n₂₂ in non-diagonal virtual node ¹²n have obtained two data elements for each.

Then in each virtual node, the data elements of each diagonal node are duplicated to other nodes. In one diagonal virtual node ¹¹n, node ¹¹n₁₁ copies its data element a₁ to node ¹¹n₁₂, and node ¹¹n₂₂ copies its data element a₂ to node ¹¹n₁₂. In another diagonal virtual node ²²n, node ²²n₁₁ copies its data element a₃ to node ²²n₁₂, and node ²²n₂₂ copies its data element a₄ to node ²²n₁₂.

Also in non-diagonal virtual node ¹²n, node ¹²n₁₁ copies its data element a₁ to node ¹²n₁₂, and node n₂₂ copies its data element a₂ to node ¹²n₂₁. These data elements a₁ and a₂ are what the diagonal nodes ¹²n₁₁ and ¹²n₂₂ have obtained as a result of the above relaying in the row direction. Further, node ¹²n₁₁ copies its data element a₃ to node ¹²n₂₁, and node ¹²n₂₂ copies its data element a₄ to node ¹²n₁₂. These data elements a₃ and a₄ are what the diagonal nodes ¹²n₁₁ and ¹²n₂₂ have obtained as a result of the above relaying in the column direction.

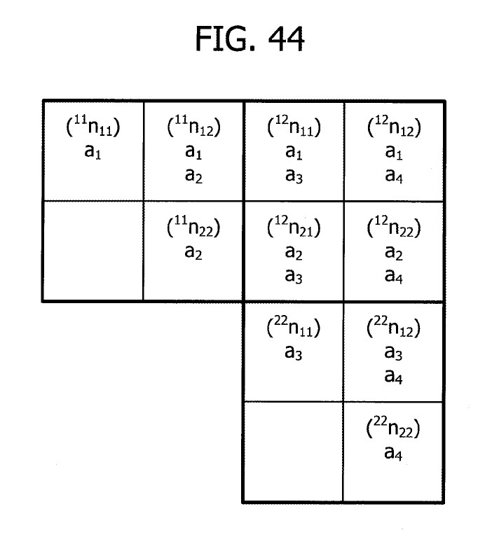

FIG. 44 is a third diagram illustrating an exemplary data arrangement according to the ninth embodiment. This example depicts the state after the internal data duplication in virtual nodes is finished. That is, a single data element resides in diagonal nodes ¹¹n₁₁, ¹¹n₂₂, ²²n₁₁, and ²²n₂₂ in the diagonal virtual nodes, whereas two data elements reside in the other nodes. The former nodes locally execute a triangle join, while the latter nodes locally execute an exhaustive join. As can be seen from FIG. 44, the illustrated nodes completely cover the ten possible combinations of data elements of dataset A, without redundant duplication.

The proposed information processing system of the ninth embodiment provides advantages similar to those of the foregoing fifth embodiment. The ninth embodiment may further reduce unintended waiting times during inter-node communication by taking into consideration the unequal communication delays due to different physical distances between nodes. That is, the proposed system performs relatively slow communication between virtual nodes in the first place, and then proceeds to relatively fast communication within each virtual node. This feature of the ninth embodiment makes it easy to parallelize the communication, thus realizing a more efficient procedure for duplicating data elements.

### (i) Tenth Embodiment

This section describes a tenth embodiment with the focus on its differences from the foregoing third to ninth embodiments. See the previous description for their common elements and features. The tenth embodiment executes triangle joins in a different way from the one discussed in the ninth embodiment. This tenth embodiment may be implemented in an information processing system with a structure similar to that of the ninth embodiment.

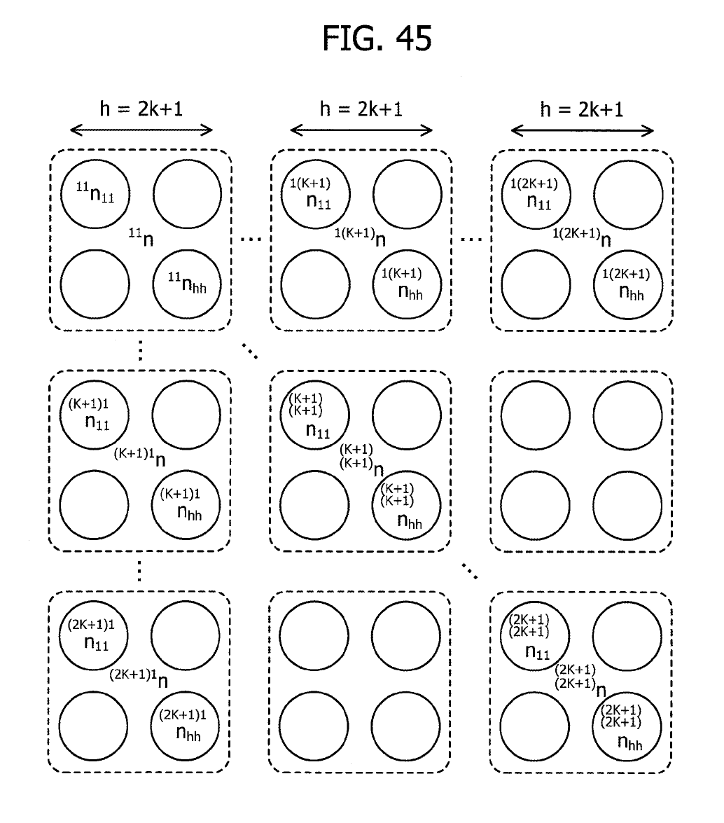

FIG. 45 illustrates a node coordination model according to the tenth embodiment. When executing triangle joins, the tenth embodiment handles a plurality of virtual nodes as if they are logically arranged in the form of a square array. Specifically, the array of nodes has a height and width of H=2K+1, where K is an integer greater than zero. The information processing system determines the row dimension H, depending on the number N of virtual nodes available for its data processing. This determination may be made by using the method described in the ninth embodiment, taking into account that the row dimension H is an odder number in the case of the tenth embodiment. Further, the tenth embodiment handles these virtual nodes as if they are logically connected in a torus topology. More specifically, it is assumed that virtual node ⁱ¹n sits on the right of virtual node ^{iH}n, and that virtual node ^{1j}n is immediately below virtual node ^{Hj}n.

Each virtual node includes a plurality of nodes logically arranged in the form of a square array with a width and height of h=2k+1. This row dimension parameter h is common to all virtual nodes. The information processing system determines the row dimension h, depending on the number of nodes per virtual node. The determination may be made by using the method described in the ninth embodiment, taking into account that the row dimension h is an odd number in the case of the tenth embodiment. Further, the nodes in each virtual node are handled as if they are logically connected in a torus topology. Dataset A is divided and assigned across all the nodes n₁₁, . . . , nₕₕ included in participating virtual nodes ¹¹n, . . . , ^{HH}n, so that the data elements are distributed evenly (or near evenly) to those nodes without needless duplication. The data elements are then duplicated from virtual node to virtual node. Subsequently the data elements are duplicated within each closed domain of the virtual nodes.

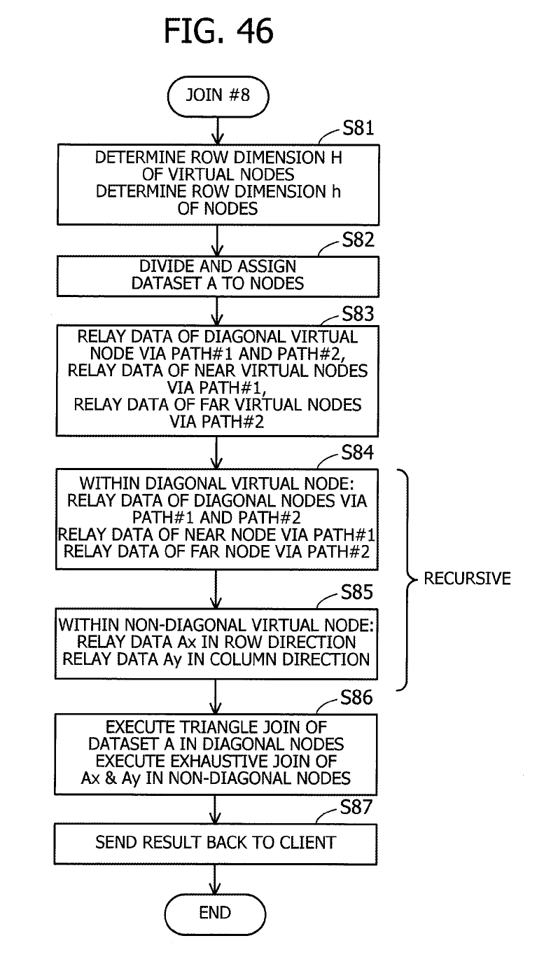

FIG. 46 is a flowchart illustrating an exemplary procedure of joins according to the tenth embodiment. Each step of the flowchart will be described below.

(S81) Based on the number of virtual nodes available for computation of triangle joins, the system control unit 212 determines the row dimension H of virtual nodes and defines their logical connections. The system control unit 212 also determines the row dimension h of nodes as a common parameter of virtual nodes.

(S82) The system control unit 212 divides dataset A specified by the client 31 into as many subsets as the number of virtual nodes that participate in a triangle join. The system control unit 212 assigns the resulting subsets to those virtual nodes. In each virtual node, the virtual node control unit subdivides the assigned subset into as many smaller subsets as the number of nodes in that virtual node and assigns the divided subsets to those nodes. The input dataset A is distributed to a plurality of nodes as a result of the above operation. As an alternative, the assignment of dataset A may be performed upon a request from the client 31 before the node 21 receives a start command for data processing. As another alternative, the dataset A may be given as an output of previous data processing at these nodes. In this case, the system control unit 212 may find that dataset A has already been assigned to relevant nodes.

(S83) The system control unit 112 commands the deputy node in each virtual node to initiate “near-node relaying” and “far-node relaying” among the virtual nodes, with respect to the locations of diagonal virtual nodes. In response, the virtual node control unit of each deputy node commands each node in relevant virtual nodes to execute these two kinds of relaying operations. The execution units in such nodes relay the subsets of dataset A by communicating with their counterparts in other virtual nodes.

The near-node relaying among virtual nodes delivers data elements along a right-angled path (path #1) that runs from virtual node ^{(i+2k)i}n up to virtual node and then turns right to virtual node ^{i(i+k)}n. The far-node relaying, on the other hand, delivers data elements along another right-angled path (path #2) that runs from virtual node ^{(i+k)i}n up to virtual node ⁱⁱn and then turns right to virtual node ^{i(i+2k)}n. (Subsets assigned to the diagonal virtual nodes ⁱⁱn are each divided evenly (or near evenly) into two halves, such that their difference in the number of data elements does not exceed one. One half is then duplicated to the virtual nodes on path #1 by the near-node relaying, while the other half is duplicated to the virtual nodes on path #2 by the far-node relaying. The near-node relaying also duplicates subsets of virtual nodes ⁱ⁽ⁱ⁺¹⁾n to ^{i(i+k)}n to n to other virtual nodes on path #1. The far-node relaying also duplicates subsets of virtual nodes ^{(i+k+1)}n to ^{i(i+2k)}n to other virtual nodes on path #2.

(S84) The system control unit 212 commands the deputy node of each diagonal virtual node ¹¹n, ²²n, . . . , ^{HH}n to duplicate data elements within the individual virtual nodes. In response, the virtual node control unit in each deputy node commands the nodes in the relevant virtual node to execute “near-node relaying” and “far-node relaying” with respect to the locations of diagonal nodes. The execution unit in each node duplicates data elements, including those initially assigned thereto and those received from other virtual nodes, to other nodes by using the same method discussed in the eighth embodiment.

(S85) The system control unit 212 commands the deputy node of each non-diagonal virtual node to duplicate data elements within the individual virtual nodes. In response, the virtual node control unit in each deputy node commands the nodes in the relevant virtual node to execute relaying in both the row and column directions. The execution unit in each node relays subset Ax in the row direction and subset Ay in column direction. Here, the subset Ax is a collection of data elements received during the course of relaying from one virtual node, and the subset Ay is a collection of data elements received during the course of relaying from another virtual node. In other words, data elements are duplicated within a virtual node in a similar way to the duplication in the case of exhaustive joins. Steps S84 and S85 may be executed recursively in the case where the virtual nodes are nested in a multiple-layer structure. This recursive operation may be implemented by causing the virtual node control unit to inherit the above-described role of the system control unit 212. The same may apply to step S82.

(S86) The system control unit 212 commands the deputy node of each diagonal virtual node ¹¹n, ²²n, . . . , ^{HH}n to execute a triangle join. In response, the virtual node control unit in each such deputy node commands the diagonal nodes n₁₁, n₂₂, . . . , nₕₕ to execute a triangle join, while instructing the non-diagonal nodes to execute an exhaustive join. The execution unit in each diagonal node locally executes a triangle join of its own subset and stores the result in a relevant data storage unit. The execution unit in each non-diagonal node locally executes an exhaustive join between subsets Ax and Ay and stores the result in a relevant data storage unit. The subset Ax is a collection of data elements received during the course of relaying from one virtual node, and the subset Ay is a collection of data elements received during the course of relaying from another virtual node.

The system control unit 212 also commands the deputy node of each non-diagonal virtual node to execute an exhaustive join. In response, the virtual node control unit of each such deputy node commands the nodes in the relevant virtual node to execute an exhaustive join. The execution unit in each non-diagonal node locally executes an exhaustive join between subsets Ax and Ay and stores the result in a relevant data storage unit. The subset Ax is a collection of data elements received during the course of relaying in the row direction, and the subset Ay is a collection of data elements received during the course of relaying in the column direction.

(S87) The system control unit 212 sees that every participating node has finished step S86, thus notifying the requesting client 31 of completion of the requested triangle join. The system control unit 212 may further collect result data from the data storage units of nodes and send it back to the client 31. Or alternatively, the system control unit 212 may allow the result data to stay in the nodes.

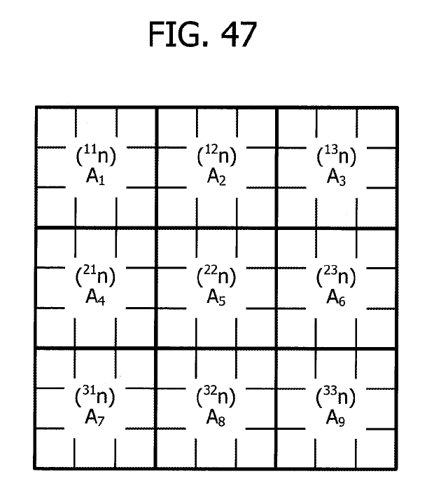

FIG. 47 is a first diagram illustrating an exemplary data arrangement according to the tenth embodiment. In this example, nine virtual nodes ¹¹n, ¹²n, . . . , ³³n are logically arranged in a 3×3 array to execute a triangle join. Dataset A is assigned to these nine virtual nodes in a distributed manner. In other words, dataset A is divided into nine subsets A₁ to A₉ and assigned to nine virtual nodes ¹¹n, ¹²n, . . . , ³³n, respectively, where one virtual node acts as if it is a single node.

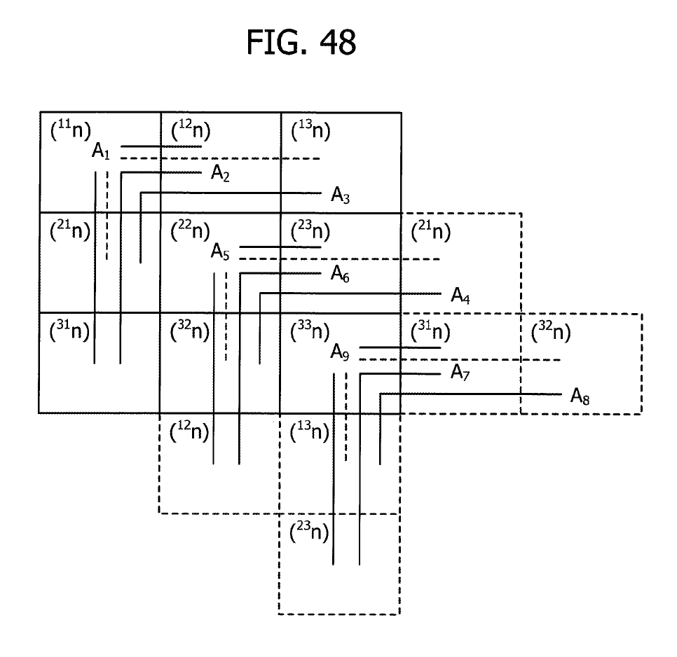

FIG. 48 is a second diagram illustrating an exemplary data arrangement according to the tenth embodiment. The foregoing relaying method of the eighth embodiment is similarly applied to the nine virtual nodes to duplicate their assigned data elements. As previously described, duplication of data elements between two virtual nodes is implemented as that between each pair of corresponding nodes.

More specifically, subset A₁ assigned to virtual node ¹¹n is divided into two halves, one being copied to virtual nodes ¹²n, ²¹n, and ³¹n by near-node relaying, the other being copied to virtual nodes ¹²n, ¹³n, and ²¹n by far-node relaying. Subset A₂ assigned to virtual node ¹²n is copied to virtual nodes ¹¹n, ²¹n, and ³¹n by near-node relaying. Subset A₃ assigned to virtual node ¹³n is copied to virtual nodes ¹¹n, ¹²n, and ²¹n by far-node relaying.

Similarly to the above, subset A₅ assigned to virtual node ²²n is divided into two halves, one being copied to virtual nodes ²³n, ³²n, and ¹²n by near-node relaying, the other being copied to virtual nodes ²³n, ²¹n, and ³²n by far-node relaying. Subset A₆ assigned to virtual node ²³n is copied to virtual nodes ²²n, ³²n, and ¹²n by near-node relaying. Subset A₄ assigned to virtual node ²¹n is copied to virtual nodes ²²n, ²³n, and ³²n by far-node relaying.

Further, subset A₉ assigned to virtual node ³³n is divided into two halves, one being copied to virtual nodes ³¹n, ¹³n, and ²³n by near-node relaying, the other being copied to virtual nodes ³¹n, ³²n, and ¹³n by far-node relaying. Subset A₇ assigned to virtual node ³¹n is copied to virtual nodes ³³n, ¹³n, and ²³n by near-node relaying. Subset A₈ assigned to virtual node ³²n is copied to virtual nodes ³³n, ³¹n, and ¹³n by far-node relaying.

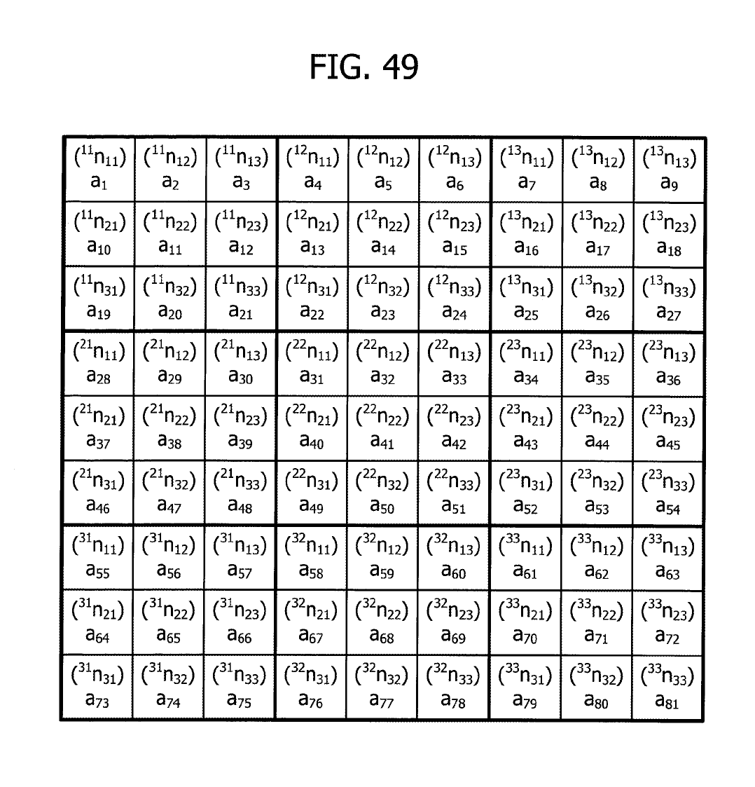

FIG. 49 is a third diagram illustrating an exemplary data arrangement according to the tenth embodiment. In this example, nine virtual nodes ¹¹n, ¹²n, . . . , ³³n are each formed from nine nodes n₁₁, n₁₂, . . . , n₃₃. Dataset A is formed from 81 data elements a₁ to a₈₁. This means that every node is uniformly assigned one data element. For example, one data element a₁ is assigned to node ¹¹n₁₁, and another data element a₈₁ is assigned to node ³³n₃₃.

Upon completion of initial assignment of data elements, the near-node relaying and far-node relaying are performed among the associated nodes of different virtual nodes, with respect to the locations of diagonal virtual nodes ¹¹n, ²²n, and ³³n. For example, data element a₁ assigned to node ¹¹n₁₁ is copied to nodes ¹²n₁₁, ²¹n₁₁, and ³¹n₁₁ by near-node relaying. This node ¹¹n₁₁ does not undergo far-node relaying because it contains only one data element. Data element a₄ assigned to node ¹²n₁₁ is copied to nodes ¹¹n₁₁, ²¹n₁₁, and ³¹n₁₁ by near-node relaying. Data element a₇ assigned to node ¹³n₁₁ is copied to nodes ¹¹n₁₁, ¹²n₁₁, and ²¹n₁₁ by far-node relaying.

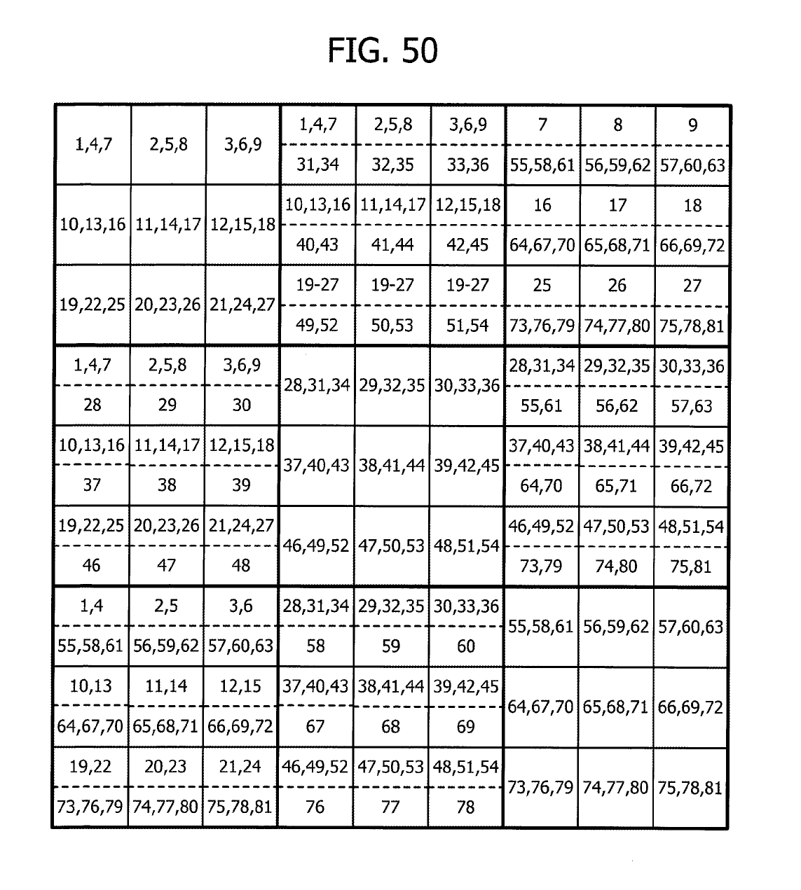

FIG. 50 is a fourth diagram illustrating an exemplary data arrangement according to the tenth embodiment. Specifically, FIG. 50 depicts the result of the duplication of data elements discussed above in FIG. 49. Note that the numbers seen in FIG. 50 are the subscripts of data elements. For example, node ¹¹n₁₁ has collected three data elements a₁, a₄, and a₇. Node ¹²n₁₁ has collected data elements a₁, a₄, and a₇ as subset Ax and data elements a₃₁ and a₃₄ as subset Ay. Node ¹³n₁₁ has collected one data element a₇ as subset Ax and three data elements a₅₅, a₅₈, an a₆₁ as subset Ay. Upon completion of data duplication among virtual nodes, local duplication of data elements begins in each virtual node.

Specifically, the diagonal virtual nodes ¹¹n, ²²n, and ³³n internally duplicate their data elements by using the same techniques as in the triangle join of the eighth embodiment. Take node ¹¹n₁₁, for example. This node ¹¹n₁₁ has collected three data element a₁, a₄, and a₇. The first two data elements a₁ and a₄ are then copied to nodes ¹¹n₁₂, ¹¹n₂₁, and ¹¹n₃₁ by near-node relaying, while the last data element a₇ is copied to nodes ¹¹n₁₂, ¹¹n₁₃, and ¹¹n₂₁ by far-node relaying. Data element a₂, a₅, and a₈ of node ¹¹n₁₂ are copied to nodes ¹¹n₁₁, ¹¹n₂₁, and ¹¹n₃₁ by near-node relaying. Data elements a₃, a₆, and a₉ of node ¹¹n₁₃ are copied to nodes ¹¹n₁₁, ¹¹n₁₂, and ¹¹n₂₁ by far-node relaying.

In addition to the above, the non-diagonal virtual nodes internally duplicates their data elements in the row and column directions by using the same techniques as in the exhaustive join of the third embodiment. For example, data elements a₁, a₄, and a₇ (subset Ax) of node ¹²n₁₁ are copied to nodes ¹²n₁₂ and ¹²n₁₂ by row-wise relaying. Data elements a₃₁ and a₃₄ (subset Ay) of node ¹²n₁₁ are copied to nodes ¹²n₂₁ and ¹²n₃₁ by column-wise relaying.

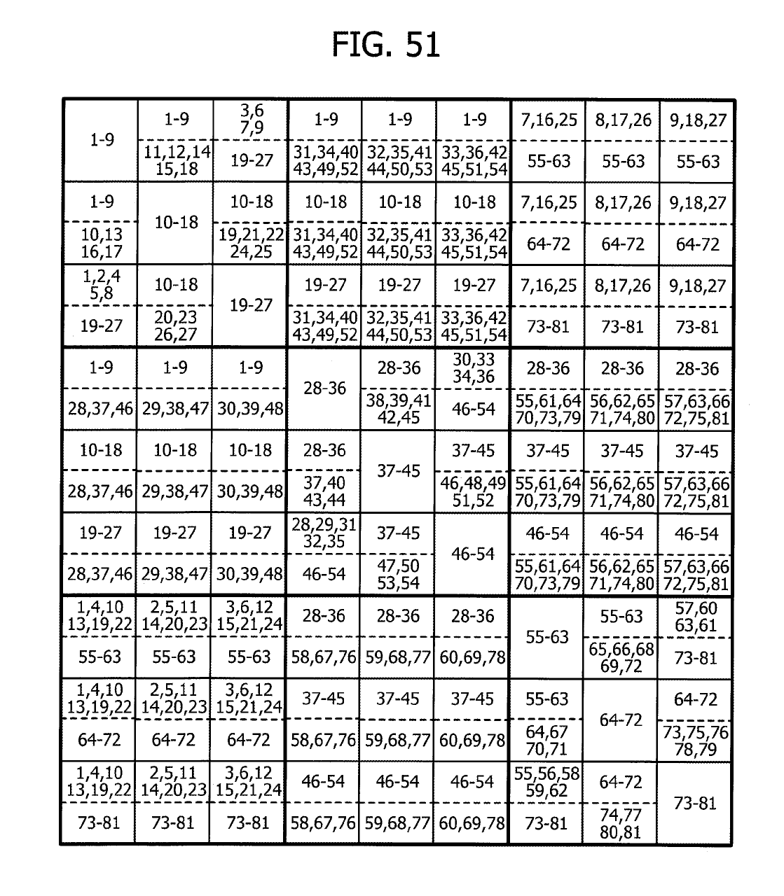

FIG. 51 is a fifth diagram illustrating an exemplary data arrangement according to the tenth embodiment. Specifically, FIG. 51 depicts an exemplary result of the above-described duplication of data elements. For example, node ¹¹n₁₁ has collected data elements a₁ to a₉. Node ¹¹n₁₂ has collected data elements a₁ to a₉ (subset Ax) and data elements a₁₁, a₁₂, a₁₄, a₁₅, and a₁₈ (subset Ay). Node ¹²n₁₁ has collected data elements a₁ to a₉ (subset Ax) and data element a₂₁, a₃₄, a₄₀, a₄₃, a₄₉, and a₅₂ (subset Ay).

In each diagonal virtual node ¹¹n, ²²n, and ³³n, the diagonal nodes n₁₁, n₂₂, and n₃₃ locally execute a triangle join with the collected subsets. The non-diagonal nodes, on the other hand, locally execute an exhaustive join of subsets Ax and Ay that they have collected. For example, diagonal node ¹¹n₁₁ applies the map function to 45 possible combinations derived from its data elements a₁ to a₉. Node ¹¹n₁₂ applies the map function to 45 ordered pairs by selecting one of the nine data elements a₁ to a₉ and one of the five data elements a₁₁, a₁₂, a₁₄, a₁₅, and a₁₈. Node ¹²n₁₁ applies the map function to 54 ordered pairs by selecting one of the nine data elements a₁ to a₉ and one of the six data elements a₃₁, a₃₄, a₄₀, a₄₃, a₄₉, and a₅₂.

As can be seen from the above description, the tenth embodiment duplicates data among virtual nodes for triangle joins. Then the diagonal virtual nodes internally duplicate data for triangle joins in a recursive manner, whereas the non-diagonal virtual nodes internally duplicate data for exhaustive joins. With the duplicated data, the diagonal nodes in each diagonal virtual node (i.e., diagonal nodes when the virtualization is canceled) locally execute a triangle join, while the other nodes locally execute an exhaustive join. In the example of FIG. 51, 3321 combinations of data elements derive from dataset A. The array of 81 nodes covers all these combinations, without redundant duplication.

The above-described tenth embodiment makes it easier to parallelize the communication even in the case where a triangle join is executed by a plurality of nodes connected via a plurality of different switches. The proposed information processing system enables efficient duplication of data elements similarly to the ninth embodiment. The tenth embodiment is also similar to the eighth embodiment in that data elements are distributed to a plurality of nodes as evenly as possible for execution of triangle joins. It is therefore possible to use the nodes efficiently in the initial phase of data duplication.

According to an aspect of the embodiments, the proposed techniques enable efficient transmission of data elements among the nodes for their subsequent data processing operations.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A method of distributed processing, comprising:
assigning data elements to a plurality of nodes sitting at node locations designated by first-axis coordinates and second-axis coordinates in a coordinate space, the node locations including a first location that serves as a base point on a diagonal line of the coordinate space, second and third locations having the same first-axis coordinates as the first location, and fourth and fifth locations having the same second-axis coordinates as the first location;
performing first, second, and third transmissions, with each node location on the diagonal line which is selected as the base point, wherein:
the first transmission transmits the assigned data elements from the node at the first location as the base point to the nodes at the second and fourth locations, as well as to the node at either the third location or the fifth location,
the second transmission transmits the assigned data elements from the nodes at the second locations to the nodes at the first, fourth, and fifth locations, and
the third transmission transmits the assigned data elements from the nodes at the third locations to the nodes at the first, second, and fourth locations; and
causing the nodes to execute a data processing operation by using the data elements assigned thereto by the assigning and the data elements received as a result of the first, second, and third transmissions.

2. The method according to claim 1, wherein:
the plurality of nodes includes at least one diagonal node sitting on the diagonal line and at least one non-diagonal node sitting off the diagonal line;
the diagonal node exerts the data processing operation on each combination of data elements collected by the diagonal node as the node at the first location; and
the non-diagonal node exerts the data processing operation on each combination of data elements selected from two sets of data elements collected by setting two different base points on the diagonal line.

3. The method according to claim 2, wherein:
the coordinate space has dimensions of (2K+1) nodes by (2K+1) nodes, where K is an integer greater than zero; and
the plurality of nodes include K nodes at the second locations, K nodes at the third locations, K nodes at the fourth locations, and K nodes at the fifth locations.

4. A distributed processing system comprising:
a plurality of nodes sitting at node locations designated by first-axis coordinates and second-axis coordinates in a coordinate space, the node locations including a first location that serves as a base point on a diagonal line of the coordinate space, second and third locations having the same first-axis coordinates as the first location, and fourth and fifth locations having the same second-axis coordinates as the first location,
wherein the nodes are configured to perform a procedure including:
performing first, second, and third transmissions, with each node location on the diagonal line which is selected as the base point, wherein:
the first transmission transmits data elements from the node at the first location as the base point to the nodes at the second and fourth locations, as well as to the node at either the third location or the fifth location,
the second transmission transmits data elements from the nodes at the second locations to the nodes at the first, fourth, and fifth locations, and
the third transmission transmits data elements from the nodes at the third locations to the nodes at the first, second, and fourth locations; and
executing a data processing operation by using the data elements assigned thereto by the assigning and the data elements received as a result of the first, second, and third transmissions.
